(19) United States
(12) Patent Application Publication
(10) Pub. No.: US 2023/0325908 A1
(43) Pub. Date: Oct. 12, 2023

(54) METHOD OF PROVIDING INTERIOR DESIGN MARKET PLATFORM SERVICE USING VIRTUAL SPACE CONTENT DATA-BASED REALISTIC SCENE IMAGE AND DEVICE THEREOF

(71) Applicant: ARCHIDRAW. INC., Seoul (KR)

(72) Inventors: Jusung LEE, Gwangmyeong-si (KR); Jong Seon HONG, Seoul (KR)

(21) Appl. No.: 18/042,293

(22) PCT Filed: Aug. 20, 2021
(86) PCT No.: PCT/KR2021/011152

§ 371 Date: Feb. 20, 2023

(30) Foreign Application Priority Data
Aug. 20, 2020 (KR) 10-2020-0104440
Aug. 20, 2020 (KR) 10-2020-0104441
Aug. 20, 2020 (KR) 10-2020-0104442
Aug. 20, 2020 (KR) 10-2020-0104443

(51) Int. Cl. G06Q 30/0601; G06T 15/20; G06Q 30/0207

(52) U.S. Cl. CPC G06Q 30/0643; G06T 15/20; G06T 2210/04; G06Q 30/0222; G06Q 30/0621

(57) ABSTRACT

In a method according to an example of the present disclosure, an operation method of a service providing device includes a step of processing distributed rendering based on virtual space content data manufactured by one or more user terminals to configure one or more realistic scene image contents; a step of matching the one or more realistic scene image contents to manufacturer information to register them on a database; a step of providing an ordering interface authoring service using the realistic scene image for an interior design business operator terminal; and a step of registering interior design product information based on authoring data inputted from the interior design business operator terminal on an interior design market platform interface.

### TECHNICAL FIELD

The present disclosure relates to a method of providing a service and a device thereof. More specifically, the present disclosure relates to a method of providing an interior design market platform service using virtual space content data-based realistic scene image and a device thereof.

### BACKGROUND ART

In general, when working on a drawing design of a construction, one installs a CAD program on a personal computer or laptop computer, makes a drawing using a device such as a mouse or tablet, and produces a result. However, as society develops from industrial society to information society, virtual reality technologies which may more easily provide a user with 3-dimensional modeling results itself other than drawings in a user experience form to substitute for a function of a model house and the like emerge.

For example, various methods to produce Virtual Reality (VR) or Augmented Reality (AR) with aims for a virtual tour, an interior design or a furniture arrangement simulation (or indoor simulation) of the interior in a construction (a house, an apartment, an office, a hospital, a church, and the like), and provide a user with an environment, a situation, and the like based thereon as a simulation for interaction are proposed.

For the above, a method of producing 3-dimensional data of a construction or an indoor structure with handwork or a 3D scanner in advance, providing virtual reality based thereon and the like may be used. However, in the case of this method, not only there are difficulties in the manufacture due to needs of a 3-dimensional construction modeling process according to estimations from scanning information, drawings, or the like but also there is a problem that its accuracy is lowered due to limitations of data processing and handwork.

Also, in the case that a user wants to make an interior design with furniture or products which are arranged in an indoor structure as one likes, the user should install them accurately and arrange them coordinately in a 3-dimensional space but this work is very difficult if the user is not a professional 3D designer. Accordingly, the actual state is that professional manpower is needed to practically structuralize and produce indoor information and an interior design of a construction only with current technologies and time and costs therefor are excessively required.

Also, the indoor information and interior design established in this way are currently provided via a display device which displays a virtual space interior design in a 2-dimensional or 3-dimensional videos.

This display device may output various furniture and objects which are shown on a view video according to a user view point based on virtual space interior design content data, and in general, a user may select any one of them and input movement of a furniture position or be provided with detailed information for purchase and the like.

However, in order to provide this information, it should be possible to output a scene image in which virtual space interior design content data is rendered in 3-dimensions via display devices of users.

In particular, in order to show 3-dimensional rendering as a more realistic image, a technology to which a global illumination rendering method based on ray tracing that analyzes physical interaction of light and a medium is applied and which may show rendering effects like actual photos is recently proposed.

Here, rendering cannot be substituted with handwork other than modeling or animation in which quality can be easily supplemented by handwork, so that which rendering technology is used may greatly affect performances and may determine reality and quality of videos generated therefrom. Compared to the past, as global illumination and shading technologies develop, rendering of extremely realistic videos becomes possible but for the above, much time is still needed.

Despite development of rendering technologies and fast development in a speed of a computer for calculating rendering, requirements for required video quality also become high together, and thus the situation is that final rendering necessary time is not shortened. The reason that to actually obtain a rendering result with respect to one scene takes from minimum minutes to maximum days is that quality of required videos is significantly enhanced.

Therefore, the actual state is that there are still difficulties in rapidly performing this rendering processing with respect to content data with high complexity and high variety in which various spaces and objects are arranged such as virtual space interior design contents and providing it for a user terminal.

Also, since realistic scene rendering such as global illumination-based rendering processing tracks a movement path fired from a light source, if a specific object is replaced, the whole scene should be reoperated. Therefore, additional operation quantity due to object conversion is also greatly increased, so that it needs excessive computing performances and data throughput and it has limitations when provided as a commercial service.

To overcome the above, a method to separate only a specific object within a scene image and simply replace it, but the actual state is that there is a problem that reality and service quality are lowered due to a sense of difference resulting from surrounding afterimages of a light source and the existing object.

Meanwhile, various on-line market platforms for constructing by an interior design or selling interior design products and the like recently emerge, and these on-line market platforms provide a screen interface to check an interior design, an esthetic sense of products, or the like in advance using photos of the space which is constructed by the interior design or photos of the space where interior design products are arranged.

However, as promotion competition within interior design on-line market platforms becomes keen, sellers who take photographs of more qualified interior designs or interior design products and use them for promotion increase.

In particular, as interior design photos with high costs which are taken by photo specialists using a high performance camera and the like in a photo studio having a filming site and the like are utilized, the actual state is that a reversal of the order of host and guest appears such that sales volume or popularity is swayed according to a composition or quality of photos other than aesthetic impression of the interior design or product itself.

Since costs required for taking interior design photos mostly result from human resources with high professionality and camera equipment, there is a problem that sellers pay excessive costs for photography other than quality of the product itself for competition. This cost payment is reflected on interior design services and product costs, and consequently, it is followed by consumer complaints due to degradation of overall services and product quality in an interior design market, cost increase, and the like.

### DISCLOSURE OF INVENTION

### Technical Problem

The present disclosure is conceived to solve the aforementioned problems, and there is an objective to provide a market platform interface and a market platform service thereof wherein the market platform interface establishes an objective and realistic interior design scene image database in a distributed rendering method based on virtual space content data which is produced and shared by general users and makes it possible to sell interior designs and products using images of an interior design scene image database to interior design business operators and product sellers, and thus costs required for taking interior design photos and the like may be reduced and also realistic scene images shared by different users may be utilized for services and product sales.

### Technical Solution

An operation method of a service providing device according to an example of the present disclosure for solving the problems as the above includes a step of processing distributed rendering based on virtual space content data manufactured by one or more user terminals to configure one or more realistic scene image contents; a step of matching the one or more realistic scene image contents to manufacturer information to register them on a database; a step of providing an ordering interface authoring service using the realistic scene image for an interior design business operator terminal; and a step of registering interior design product information based on authoring data inputted from the interior design business operator terminal on an interior design market platform interface.

Also, the service providing device according to an example of the present disclosure for solving the problems as the above includes a space and interior design rendering portion which processes distributed rendering based on virtual space content data manufactured by one or more user terminals to configure one or more realistic scene image contents; and a service providing portion which matches the one or more realistic scene image contents to manufacturer information to register them on a database, wherein the service providing portion includes virtual space interior design content manufacturing module which provides an ordering interface authoring service using the realistic scene image for an interior design business operator terminal; and a market platform interface module which registers interior design product information based on authoring data inputted from the interior design business operator terminal on an interior design market platform interface.

The operation method of the service providing device according to an example of the present disclosure for solving the problems as the above includes a step of processing distributed rendering based on 3-dimensional furniture data to configure one or more realistic scene image contents corresponding to a furniture item to be sold; a step of providing a furniture sales interface authoring service using the realistic scene image contents for a furniture seller terminal; and a step of registering furniture product information based on authoring data inputted from the furniture seller terminal on a furniture sales market platform interface.

Also, the service providing device according to an example of the present disclosure for solving the problems as the above includes a space and interior design rendering portion which processes distributed rendering based on 3-dimensional furniture data to configure one or more realistic scene image contents corresponding to a furniture item to be sold; and a service providing portion which provides a furniture sales interface authoring service using the realistic scene image contents for a furniture seller terminal and registers furniture product information based on authoring data inputted from the furniture seller terminal on a furniture sales market platform interface.

The operation method of the service providing device according to an example of the present disclosure for solving the problems as the above includes a step of processing distributed rendering based on virtual space content data manufactured by one or more user terminals to configure one or more realistic scene image contents; a step of matching the one or more realistic scene image contents to manufacturer information to register them on a database; a step of providing a real estate brokerage interface authoring service using the realistic scene image for a real estate business operator terminal; and a step of registering an real estate product information based on authoring data inputted from the real estate business operator terminal on a real estate market platform interface.

Also, the service providing device according to an example of the present disclosure for solving the problems as the above includes a space and interior design rendering portion which processes distributed rendering based on virtual space content data manufactured by one or more user terminals to configure one or more realistic scene image contents; and a service providing portion which matches the one or more realistic scene image contents to manufacturer information to register on a database, wherein the service providing portion includes a virtual space interior design content manufacturing module which provides a brokerage interface authoring service using the realistic scene image for a real estate business operator terminal; and a market platform interface module which registers a real estate product information based on authoring data inputted from the real estate business operator terminal on a real estate market platform interface.

Meanwhile, the operation method of the service providing device according to an example of the present disclosure for solving the problems as the above may be realized by a program for implementing the method on a computer, and a computer readable recording medium on which the program is recorded.

### Effects of the Invention

According to an example of the present disclosure, it is possible to provide a market platform interface and service wherein the market platform interface establishes an objective and realistic interior design scene image database in a distributed rendering method based on virtual space content data which is produced and shared by general users and makes possible to sell interior designs and products using images of an interior design scene image database to interior design business operators and product sellers, and thus costs required for taking interior design photos and the like may be reduced and also realistic scene images shared by different users may be utilized for services and product sales.

Also, according to an example of the present disclosure, a user may create space and interior design information intuitionally and conveniently without making a separate precise design or requesting work to a specialist via user style-based automated processing with respect to an arranged space and interior design on indoor structure information in order to configure realistic scene images.

Also, according to an example of the present disclosure, virtual space contents configured according to various methods such as space and interior designs are efficiently, rapidly, and priorly rendered via a cloud service network, and global illumination and shading effects are applied, so that 3-dimensional scene images of a virtual space interior design like a natural abundant actual image like reality may be provided via a user terminal.

### BRIEF DESCRIPTION OF THE DRAWINGS

FIG. 1 is a view for schematically describing a whole system according to an example of the present disclosure.

FIG. 2 is a block diagram for more specifically describing a service providing device according to an example of the present disclosure.

FIG. 3 is a block diagram for more specifically describing a service providing portion according to an example of the present disclosure.

FIG. 4 is a flow chart for more specifically describing a service providing method according to an example of the present disclosure.

FIG. 5 is a view for describing a realistic scene image-based market platform interface according to an example of the present disclosure.

FIGS. 6 to 8 exemplifies an indoor structure information interface outputted from a service providing device according to method implementation according to an example of the present disclosure.

FIG. 9 is a block diagram which more specifically shows a space and interior design rendering portion according to an example of the present disclosure, and FIGS. 10 to 11 are illustrative views of realistic scene images rendering-processed according to an example of the present disclosure.

FIGS. 12 to 15 are flow charts and a reference view for more specifically describing operations of the rendering portion according to an example of the present disclosure.

FIGS. 16 to 20 are a flow chart and reference views for more specifically describing object conversion operations of the rendering portion according to an example of the present disclosure.

FIGS. 21 to 25 are views for describing a system and an operation according to a second example of the present disclosure.

FIGS. 26 to 30 are views for describing a system and an operation according to a third example of the present disclosure.

FIGS. 31 to 35 are views for describing a system and an operation according to a fourth example of the present disclosure.

### MODE FOR CARRYING OUT THE INVENTION

The content hereinafter merely exemplifies principles of the present disclosure. Therefore, even though the principles of the present disclosure are not definitely described or shown, those skilled in the art may realize them and may invent various devices included in concepts and ranges of the present disclosure. Also, in principle, all conditional terminologies and examples noted in the specification are definitely intended to have an aim for understanding concepts of the present disclosure, wherein it should be understood that examples and states particularly noted in this way are not restrictive.

Also, it should be understood that all detailed description noted not only principles, viewpoints and examples but also a specific example of the present disclosure are intended to include structural and functional equivalents of these matters. Also, it should be understood that these equivalents include not only currently known equivalents but also equivalents to be prospectively developed, that is, all elements invented to perform the same function regardless of a structure.

Therefore, for example, it should be understood that a block diagram of the specification shows a conceptional viewpoint of an exemplary circuit which specifies the principles of the present disclosure. In a similar way, all flow charts, a state transition diagram, pseudo code, and the like may be substantially shown on a computer readable medium, and regardless of whether a computer or a processor is definitely shown, it should be understood that various processors implemented by a computer or a processor are shown.

Functions of various elements shown in drawings including a functional block illustrated as a processor or a similar concept to that may be provided by use of hardware having capability to implement software related to not only dedicated hardware but also proper software. When provided by a processor, the functions may be provided by a single dedicated processor, a single shared processor, or a plurality of individual processors, wherein some of them may be shared.

Also, exact use of terminologies presented as a processor, control, or a similar concept to that should not be interpreted by exclusively citing hardware having capability to implement software, but it should be understood that without limitations, digital signal processor (DSP) hardware, ROM for storing software, RAM, and a non volatile memory are suggestively included. Well-known or commonly used hardware may be included.

In the scope of claims of the specification, components expressed as means for performing functions described in the detailed description are intended to include all methods which perform functions including all forms of software including for example, combinations of circuit elements which perform the functions or firmware/micro code and the like and are combined with a proper circuit for implementing the software to perform the functions. It should be understood that since the present disclosure defined by the scope of claims is combined with functions provided by variously noted means and is combined with a method required by claims, any means which may provide the functions is equivalent to that understood from the present specification.

The aforementioned objectives, features, and advantages become clearer via the following detailed description related to appended drawings and accordingly, those skilled in the art may easily perform technical spirit of the present disclosure. Also, when describing the present disclosure, if it is determined that the detailed description of the known technologies related to the present disclosure may make the gist of the present disclosure vague, the detailed description thereof is omitted.

Hereinafter, with reference to the appended drawings, one preferred example according to the present disclosure is specifically described.

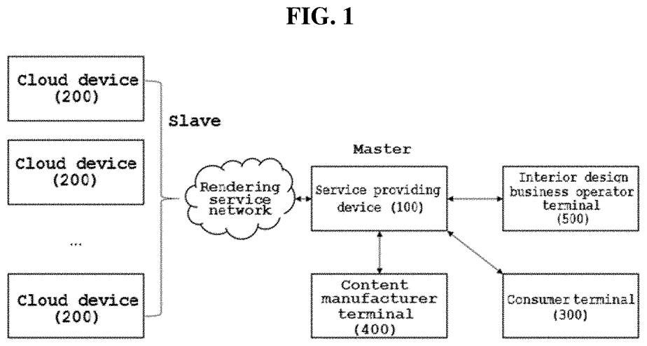

FIG. 1 is a view for schematically describing a whole system according to an example of the present disclosure.

With reference to FIG. 1, a whole system according to an example of the present disclosure includes a service providing device 100, one or more cloud devices 200, a consumer terminal 300, a content manufacturer terminal 400, and an interior design business operator terminal 500.

In advance, the consumer terminal 300, the content manufacturer terminal 400, and the interior design business operator terminal 500 described in the specification may be commonly referred to as user terminals 300, 400, 500 according to a general function. In advance, this general function is described, and then an operation of each terminal is specifically described.

The user terminals 300, 400, 500 are one or more electronic devices which operate according to user input and output a user interface, wherein various electronic equipment such as a mobile phone, a smart phone, a computer, a laptop computer, a terminal for digital broadcasting, Personal Digital Assistants (PDA), a Portable Multimedia Player (PMP), navigation, and virtual reality devices may be exemplified.

Further, the user terminals 300, 400, 500 may be interlocked with the service providing device 100 to install and operate a program or an application for performing methods according to an example of the present disclosure.

Accordingly, the service providing device 100 according to an example of the present disclosure may provide an interface of creating and editing indoor structure information outputted from user terminals 300, 400, 500 or information required for driving the interface to each user terminal 300, 400, 500, wherein the indoor structure information created according to an example of the present disclosure may be stored in the service providing device 100 or may be uploaded on a separate server (not shown) and the like and be managed according to user information.

Here, the indoor structure information may include 2-dimensional or 3-dimensional building floor plan information and may include structure information which may be coordinated with 3-dimensional modeling information to be used for indoor interior design simulation and the like. Further, the indoor structure information may include connection information of one or more bricks and each brick and may form one or more closed spaces.

To easily create this indoor structure information, the user terminals 300, 400, 500 may have a distance measuring sensor and an angle measuring sensor inside or outside and may determine indoor structure information according to user input.

Also, the service providing device 100 may obtain priorly stored or uploaded indoor structure information corresponding to user information from the user terminals 300, 400, 500 and may provide an interior design layout editing function corresponding to the obtained indoor structure information.

In particular, according to an example of the present disclosure, the service providing device 100 may provide an interior design layout automated function which may automatically process furniture interior design arrangement and space designs according to user style information analysis corresponding to indoor structure information of a user, for the user terminals 300, 400, 500.

More specifically, the service providing device 100 according to an example of the present disclosure, if the indoor structure information of the user is obtained, may create interior design layout automated information which includes a space layout and an interior design arrangement design determined corresponding to the indoor structure information according to style information analysis processing corresponding to the user and may output the interior design layout automated information via the user terminals 300, 400, 500.

Automated information outputted as the above may be used for interior design rendering processing of the indoor structure information in the service providing device 100, and the rendering-processed indoor structure information may be outputted via an indoor structure information interface of the user terminals 300, 400, 500.

Accordingly, the indoor structure information in which the interior design furniture and space layout design is automatically processed may be used for editing according to user input, information sharing and storing, and furthermore, it may be used for indoor simulation and a purchase-linked function of each arranged furniture.

For example, the service providing device 100 may provide a function which visualizes a 3-dimensional space similar with reality in a virtual space displayed on a display and the like of the user terminals 300, 400, 500 and arranges a 3-dimensional object based on interior design layout automated information on an indoor simulation graphic based on the indoor structure information. Accordingly, indoor simulation may be preferably used for a floor plan which simulates furniture to be arranged in a room and the like and a floor plan application may be included in an application which provides indoor simulation.

Accordingly, the service providing device 100 according to an example of the present disclosure may create interior design arrangement and a space layout design according to a user style according to a user input on the indoor structure information and may provide rendering information for the user terminals 300, 400, 500. Accordingly, the user may be provided with a space layout and furniture arrangement in the style that the user wants without a separate precise design or design work and may edit them and variously establish 2-dimensional and 3-dimensional indoor structure information.

For the above, a separate server device may store necessary information to provide a certain application which may be installed in the user terminals 300, 400, 500 and the indoor simulation and may provide user registration and indoor structure information management for the user of the user terminals 300, 400, 500. The user terminals 300, 400, 500 may download the application from the server device and install it.

Further, the service providing device 100 according to an example of the present disclosure may perform more realistic and almost real scene image rendering with respect to virtual space interior design contents including 3-dimensional indoor structure information and may provide rendered image data to the user terminals 300, 400, 500.

Here, the rendered image data may be a 3-dimensional image projected corresponding to a first viewpoint set corresponding to the virtual space interior design and may be image data to which one or more rendering effect operation processes for configuring a realistic scene are applied.

More specifically, the rendering effect may include effect processing to which various illumination algorithms such as a well-known REYES structure are applied. Meanwhile, REYES has a problem that a speed is fast but reality is low, and global illumination-based rendering method exquisitely interpret interaction of light and a medium more physically but has a problem that operation quantity is high and thus high-end computing is needed.

In particular, global illumination may calculate all of a direct light from a light source and an indirect light reflected from other materials, objects, walls, or the like to give a more realistic feel, wherein all phenomena such as soft shadow, Caustics, and color bleeding may be appeared via global illumination effects, and ray tracing is a method of simulating a phenomenon that light of the real world moves as it is and has a difficulty when configuring in real time even in the latest hardware of the current generation because operation quantity is very high.

Accordingly, the service providing device 100 according to an example of the present disclosure may make the cloud devices 200 distributedly perform a ray tracing process based on global illumination using a cloud-based rendering service network configured by the one or more cloud devices 200 and thus may establish effectively priorly rendered 3-dimensional virtual space interior design contents. This is based on a rendering optimized process of the service providing device 100 which may effectively share computing resources and efficiently reduce operation time.

Here, the service providing device 100 may be a master device which distributedly configures realistic scene rendering work as partial image rendering work and assigns it to the cloud devices 200, and the cloud devices 200 may be a slave device which processes partial image rendering and transfers an optimized realistic scene partial image to the service providing device 100.

More specifically, the service providing device 100 according to an example of the present disclosure may configure optimized distributed processing data for realistic distributed rendering processing of a scene image projected from the first viewpoint corresponding to 3-dimensional virtual space interior design contents to be provided to the user terminals 300, 400, 500, and may transfer configured distributed processing data to the one or more cloud devices 200 connected to the rendering service network, receive distributedly rendered realistic scene partial images, and configure a realistic scene image of the first viewpoint corresponding to the 3-dimensional virtual space interior design contents.

Accordingly, the configured realistic scene image of the first viewpoint may be provided to the user terminals 300, 400, 500, wherein the first viewpoint may be extended to a plurality of viewpoints as prior rendering is repetitively performed. Furthermore, the plurality of viewpoints may be configured as an omnidirectional point viewpoint corresponding to the 3-dimensional virtual space, so that it may be possible to provide realistic scene image-processed 720 degrees omnidirectional virtual space interior design contents according to optimization of the prior rendering and enhancement of cloud network performances.

Furthermore, the service providing device 100 according to an example of the present disclosure may provide an object conversion service within the realistic scene image, so that it may priorly create a plurality of object-converted realistic scene images for the above and may store and manage them in the database. For example, realistic scene image processing such as changing furniture to a different type of furniture within specific virtual space interior design contents may be easily provided via the prior rendering process.

Meanwhile, as aforementioned, there is a problem that in order to create the object-converted realistic scene images, a reoperating process corresponding to the whole image is required and operation quantity is very high. Also, in the case of simply replacing only an object part, there is a problem that a sense of difference occurs because of afterimages of surrounding images due to the existing object and the like and a sense of reality is lowered.

Accordingly, the service providing device 100 according to an example of the present disclosure may determine a partial conversion boundary area corresponding to an affected range by the object conversion corresponding to a first object before conversion and a second object after conversion, perform re-rendering processing of only the realistic scene image corresponding to the partial conversion boundary area, combine re-rendered scene image part with the remaining existing scene image part, and create a realistic scene image where the first object is converted to the second object. Thus, it may provide object conversion processing which may minimize operation quantity of a reoperation process and may also prevent occurrence of the sense of difference.

Further, the service providing device 100 according to an example of the present disclosure may provide a market platform service by which products of the interior design business operator may be sold using the priorly rendered 3-dimensional virtual space interior design contents to each user terminal 300, 400, 500.

Here, the priorly rendered 3-dimensional virtual space interior design contents may be configured of realistically rendered one or more realistic scene images. The realistic scene image may substitute interior design photos with high costs which are taken by photo specialists using a high performance camera and the like in a photo studio having a filming site as aforementioned with image data based on low costs and an efficient operation. Accordingly, the market platform by which human costs of photo work may be reduced and quality of images may be enhanced using 4K-grade or more photographing rendered realistic images may be provided.

For the above, the content manufacturer terminal 400 may be a user terminal which configures the 3-dimensional virtual space interior design contents as aforementioned and requests the service providing device 100 for realistic distributed rendering processing of the scene image projected from the first viewpoint, wherein the service providing device 100 may configure distributed rendering-based realistic scene image contents, match them to manufacturer information of the content manufacturer terminal 400, and store and register them on the database.

Further, the interior design business operator terminal 500 may be a user terminal of a business operator who provides interior design products and services and may generate an ordering interface including product information to be sold using realistic scene image contents registered on the service providing device 100 and request the service providing device 100 to register the generated ordering interface. The ordering interface requested to be registered may be registered on an interior design-related market platform interface provided by the service providing device 100.

For example, the product information to be sold may include an interior design construction product and the realistic scene image contents may be provided as a construction sample image of the interior design construction product. Further, in order to generate the ordering interface, the service providing device 100 may provide an ordering interface authoring service including the construction sample image to the interior design business operator terminal 500 and may register interior design product information based on authoring data inputted from the interior design business operator terminal 500, on an interior design market platform interface.

Accordingly, the service providing device 100 may provide the interior design product information including the realistic scene image contents to one or more consumer terminal 300 connected to the market platform interface. The service providing device 100 may collect ordering information inputted via the ordering interface corresponding to the interior design product information from the consumer terminal 300 and may perform payment processing.

By the process as the above, the service providing device 100 may make the interior design business operator terminal 500 generate the ordering interface which includes interior design product information with low costs and high quality using realistic scene images configured by various content manufacturer terminals 400 and may receive ordering information of the consumer terminal 300 with respect to this ordering interface and may process payment. Thus, the interior design market platform that is more efficient and with few costs may be provided.

Also, manufacturer information of the content manufacturer terminal 400 may be used for calculating rewards corresponding to the realistic scene image. For example, in case that inquiries and payment processing of the interior design product information are completed or are registered on the market platform interface, the service providing device 100 may calculate rewards with respect to use of the realistic scene image and pay or provide the rewards corresponding to the manufacturer information.

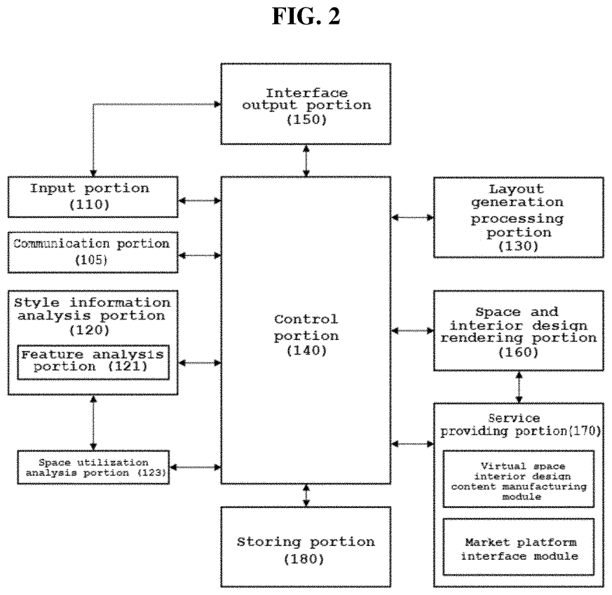

Detailed components of each device to realize the above are more specifically described with reference to FIG. 2.

With reference to FIG. 2, the service providing device 100 includes a communication portion 105, an input portion 110, a style information analysis portion 120, a layout generation processing portion 130, a control portion 140, an interface output portion 150, a space and interior design rendering portion 160, a service providing portion 170, and a storing portion 180. Since components shown in FIG. 2 are not necessary, a terminal having more components or fewer components than them may be realized.

In advance, the communication portion 105 may include one or more modules which may make wired and wireless communications between the service providing device 100 and a rendering service network or between the service providing device 100 and a network where the user terminals 300, 400, 500 are positioned possible.

For example, the communication portion 105 may include a mobile communication module, a wireless Internet module, a short range communication module, a location information module, and the like. The mobile communication module transmits and receives a wireless signal to and from at least one of a server device, a base station, an outside terminal, and a server on a mobile communication network. The wireless Internet module means a module for wireless Internet connection and may be embedded or faced in or on the service providing device 100. As wireless Internet technologies, Wireless LAN (WLAN)(Wi-Fi), Wireless broadband (Wibro), World Interoperability for Microwave Access (Wimax), High Speed Downlink Packet Access (HSDPA), and the like may be used.

The short range communication module means a module for near field communication. As short range communication technologies, Bluetooth, Radio Frequency Identification (RFID), IrDA (infrared Data Association), Ultra Wideband (UWB), ZigBee, and the like may be used.

The location information module means a module for obtaining a location of a terminal and its representative example is a Global Position System (GPS) module.

Also, for example, the communication portion 105 may receive completed indoor structure information and interior design layout information from the user terminals 300, 400, 500 or may provide indoor structure information or interior design layout information registered corresponding to user information to the user terminals 300, 400, 500. Here, the interior design layout information may be interior design layout information obtained from video information inputted from the user terminals 300, 400, 500 or may include interior design layout automated information processed in the service providing device 100.

The input portion 110 may receive and process input data for operation control of a user according to input of the user terminals 300, 400, 500.

The style information analysis portion 120 analyzes style information of a user and transfers the analyzed style information to the layout generation processing portion 130. For the above, the style information analysis portion 120 may include a feature analysis portion 121.

In advance, the style information analysis portion 120 may receive style-related information corresponding to the user via the input portion 110 and the inputted style-related information may be transferred to the feature analysis portion 121.

More specifically, the style-related information may show user preference interior design information according to user input, and the style information analysis portion 120 may analyze the user preference interior design information and yield user style information to be transferred to the layout generation processing portion 130.

Here, as a specific element showing user preference interior design information, the style-related information may include interior design video information that the user wants to establish in a similar form or style pattern information of the user which the user directly selects and inputs.

For example, in order to apply a space interior design layout in a similar form with a space interior design of a specific video or a specific image to the user's indoor structure information, the user may input the specific video or image or may input interior design photos or moving picture information or its social network service link information confirmed by a social network service as the style-related information.

Also, for example, the user may input preference style information with respect to automatically arranged interior designs as the style-related information to the user's indoor structure information. For example, the user may input various style information such as furniture's size, arrangement, matching style, or a space's size, form, number, type and the like via the user terminals 300, 400, 500 and it may be received via the input portion 110.

The feature analysis portion 121 may analyze the style-related information and obtain the user's style information and the obtained style information may be transferred to the layout generation processing portion 130. Here, the user style information may include a feature variable information for layout generation iteration processing of the layout generation processing portion 130.

More specifically, for example, the feature analysis portion 121 may perform a process of yielding a feature variable for interior design cost function evaluation based on the user's style information.

The interior design cost function is conceived to determine an optimized space and interior design layout in a layout generation processing portion 130 and may be used to evaluate a realistic arrangement level of the interior design according to a feature variable of an interior design object set corresponding to indoor structure information.

That is, the layout generation processing portion 130 may repetitively process an interior design cost function operation based on feature variable information as iteration to yield an optimized space and interior design layout, and the feature analysis portion 121 may perform style information analysis corresponding to the video information and the like, obtain feature variable information corresponding to style information of the user, and provide it to the layout generation processing portion 130.

Accordingly, the style information analyzed in the feature analysis portion 121 may be used for space layout design function evaluation of the layout generation processing portion 130, and the layout generation processing portion 130 may determine a space layout design function for correcting the interior design cost function.

For example, a layout x may include one or more interior design feature variable sets, the interior design feature variable may correspond to for example, an indoor structure, a wall, a corner, a door, and each furniture object element, and a size, form, type, location, and rotation value corresponding to each element may be assigned as each feature variable.

Further, a space utilization analysis portion 123 may process space utilization analysis for each layout. Space utilization analysis may consider elements such as, for example, a margin within a space, density, proximity between spaces according to a movement path, and the space utilization analysis portion 123 may process a function of if a specific layout is inputted, calculating its utilization and outputting it to the layout generation processing portion 130.

Also, the space utilization analysis portion 123 may be included as one element of the style information analysis portion 120. For example, the style information analyzed in the style information analysis portion 120 may include space utilization information, and accordingly, an allowable space utilization iteration threshold for each user style may be differently set.

Via this iteration process, optimized interior design layout automation information may be determined, and the determined interior design layout automation information may be transferred to a space and interior design rendering portion 160.

Meanwhile, the rendering portion 160 may perform realistic scene image rendering processing with respect to 3-dimensional virtual space interior design contents which are directly written by the user or in which the interior design layout automation information is applied to indoor structure information, and rendering processed space and interior design data may be outputted to the user terminals 300, 400, 500 via the interface output portion 150.

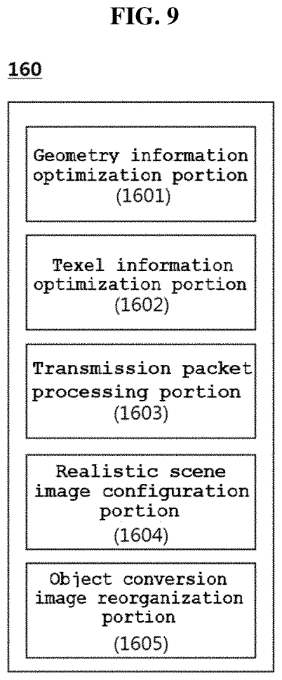

Particularly, the rendering portion 160 according to an example of the present disclosure may configure optimized distributed processing data for realistic distributed rendering processing of a scene image projected from the first viewpoint corresponding to 3-dimensional virtual space interior design contents to be provided to the user terminals 300, 400, 500, and may transfer configured distributed processing data to the one or more cloud devices 200 connected to the rendering service network, receive distributedly rendered realistic scene partial images from the cloud device 200, and configure realistic scene images of the first viewpoint corresponding to the 3-dimensional virtual space interior design contents. More specific configurations are described with reference to FIGS. 9 to 15 later.

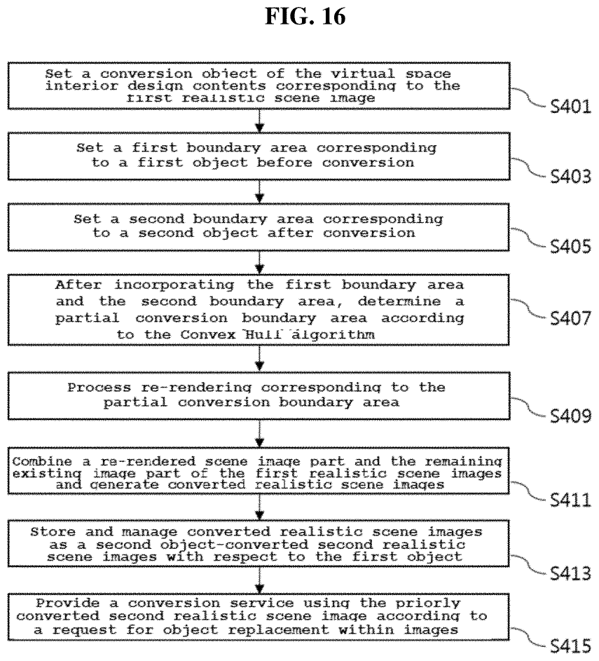

Also, the rendering portion 160 according to an example of the present disclosure may determine a partial conversion boundary area corresponding to an affected range by the object conversion corresponding to a first object before conversion and a second object after conversion, perform re-rendering processing only the realistic scene image corresponding to the partial conversion boundary area, combine re-rendered scene image part with the remaining existing scene image part, and generate a realistic scene image where the first object is converted to the second object. Thus, it may provide object conversion processing which may minimize operation quantity of a reoperation process and may also prevent occurrence of the sense of difference. More specific configurations are described with reference to FIGS. 16 to 20 later.

Further, the service providing portion 170 provides service functions such as a space interior design experience, interior design editing, furniture tagging, furniture information, and purchase information provision based on interior design layout automation information.

Further, the service providing portion 170 may include a market platform interface module for processing a market platform service and ordering information and may include a virtual space interior design content manufacturing module for supporting to manufacture and register realistic scene image contents to be used in the market platform interface module.

For example, the service providing portion 170 may make the content manufacturer terminal 400 manufacture realistic scene image contents including furniture information used for interior design arrangement, a purchase link, and the like using the virtual space interior design content manufacturing module, obtain manufacturer information and register matching on the database of a storing portion 180.

Also, for example, the service providing portion 170 may output a tagging interface of one or more of furniture information included in video images in which the interior design layout automation information is rendered via the interface output portion 150 to the user terminals 300, 400, 500 and may process a service of providing the furniture information and purchase link according to user input corresponding to the tagging interface.

Accordingly, the user not only may be provided with the automated interior design layout service but also may check detailed information and purchase information of furniture for actually applying it to the user's indoor space directly.

The interface output portion 150 is for generating output related to vision, hearing or touch by providing the interface as noted above via the user terminals 300, 400, 500, the user terminals 300, 400, 500 may include a display portion, a sound output module, an alarm portion, a haptic module, and the like, and the interface output portion 150 may output data for controlling the display portion, the sound output module, the alarm portion, the haptic module, and the like to the user terminals 300, 400, 500.

The display portion of the user terminals 300, 400, 500 displays (outputs) information provided from the service providing device 100. For example, in the case that the user terminals 300, 400, 500 are in an indoor simulation mode, User Interface (UI) or Graphic User Interface (GUI) related to an indoor simulation and a floor plan is displayed. Further, on an interface screen, a user interface for indoor structure information creation according to an example of the present disclosure may be displayed.

The display portion may include at least one of a liquid crystal display (LCD), a thin film transistor-liquid crystal display (TFT LCD), an organic light-emitting diode (OLED), a flexible display, and a 3D display.

The storing portion 180 may store a program for an operation of the control portion 140 and may temporarily store input/output data.

The storing portion 180 may include at least one type of storing media of a flash memory type, hard disk type, multimedia card micro type, a card type memory (for example, SD memory, XD memory, or the like), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disc, and an optical disc. The service providing device 100 may operate in connection with web storage which perform a storing function of the storing portion 180 on Internet.

The control portion 140 may usually control overall operations of the terminal and also, the control portion 140 may store interior design automation-processed indoor structure information in the storing portion 180 according to user input information received from the user terminals 300, 400, 500 or may process that rendered data is transferred to the user terminals 300, 400, 500 via the communication portion 105.

For example, 3-dimensional furniture object data created by the user of the user terminals 300, 400, 500, 3-dimensional space interior design data, or the interior design automation-processed indoor structure information may be matched to user account information of the service providing device 100 and may be stored and managed in the cloud device 200 or the service providing device 100.

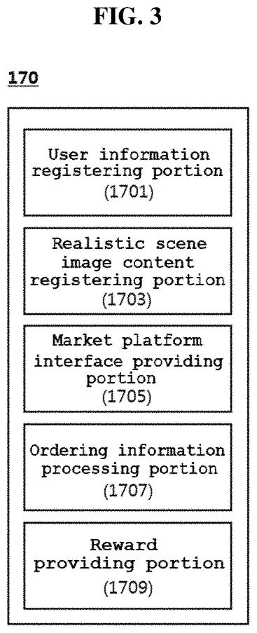

FIG. 3 is a block diagram for more specifically describing a service providing portion according to an example of the present disclosure.

Referring to FIG. 3, the service providing portion 170 according to an example of the present disclosure includes a user information registering portion 1701, a realistic scene image content registering portion 1703, a market platform interface providing portion 1705, an ordering information processing portion 1707, and a reward providing portion 1709.

The user information registering portion 1701 may receive user information of each of the consumer terminal 300, the content manufacturer terminal 400, and the interior design business operator terminal 500 and may process to priorly store and register it in the storing portion 180.

Further, the realistic scene image content registering portion 1703 may process distributed rendering based on virtual space content data manufactured by one or more user terminals according to a request of the content manufacturer terminal 400, configure one or more realistic scene image contents, match the one or more realistic scene image contents to manufacturer information, and process to store and register them in the database of the storing portion 180.

Further, the market platform interface providing portion 1705 may provide an ordering interface authoring service using the realistic scene image to the interior design business operator terminal 500 and may process to register interior design product information based on authoring data inputted from the interior design business operator terminal 500, on the interior design market platform interface. The registered product information may be shared with one or more consumer terminals 300.

Accordingly, the market platform interface providing portion 1705 may provide the interior design product information to the consumer terminal 300 via the interior design market platform interface. Here, the interior design product information may include the aforementioned realistic scene image contents.

Further, the ordering information processing portion 1707 performs confirmation and payment processing of ordering information inputted from the consumer terminal 300. Further, the ordering information processing portion 1707 may have one or more ordering payment modules (not shown) to support ordering information and payment processing of the consumer terminal 300, wherein payment information may be transferred to the reward providing portion 1709.

Further, the reward providing portion 1709 may provide or pay a priorly set rate or quantity of rewards corresponding to manufacturer information of the realistic scene image applied to the interior design product information to an account corresponding to the manufacturer information.

Further, the priorly set rate or quantity of the rewards may be determined in various ways.

For example, the priorly set rate or quantity of the rewards may be determined according to evaluation information of the realistic scene image collected via the interior design market platform interface corresponding to the interior design product information. The evaluation information may exemplify the number of searching, a rating value, the number of selecting like, and the like.

Also, the reward providing portion 1709 may receive not only rewards with respect to ordering payment but also content fees from the interior design business operator terminal if the interior design product information is registered on the interior design market platform interface and may transfer them to the user account corresponding to the manufacturer information.

Thanks to processing as the above, the realistic interior design scene image based on establishment of 3-dimensional indoor space data of each user may be easily configured, and it is possible to provide the market platform interface based on the configured realistic scene image contents. Accordingly, ordering interface creation of the interior design product information based on the competitive realistic interior design scene image is easily processed without needs of excessive human resources.

Also, the manufacturer information of these realistic interior design scene image contents is registered, so that it is possible to provide rewards according to fee charging or reward setting of the interior design business operator. Thus, participation of the content manufacturers may be increased and the market platform service may be activated.

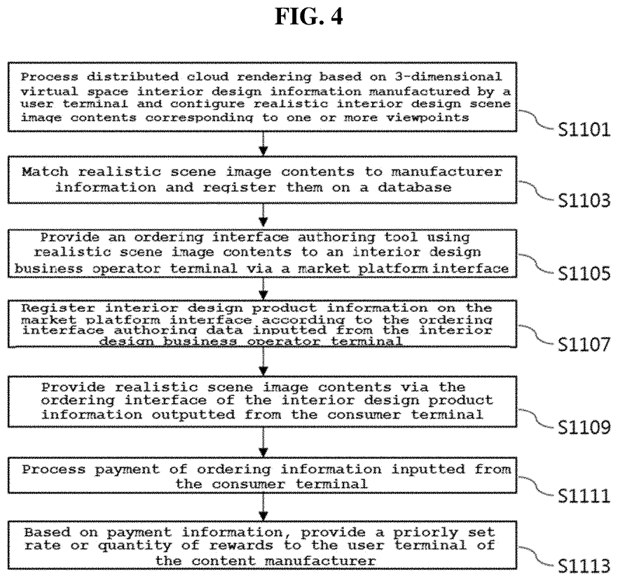

FIG. 4 is a flow chart for more specifically describing a service providing method according to an example of the present disclosure.

Referring to FIG. 4, the service providing device 100 according to an example of the present disclosure processes distributed cloud rendering based on 3-dimensional virtual space interior design information manufactured by one or more user terminals 300, 400, 500 and configures realistic interior design scene image contents corresponding to one or more viewpoints (S1101).

Further, the service providing device 100 matches the realistic scene image contents to the manufacturer information and registers them on the database of the storing portion 180 (S1103).

Further, the service providing device 100 provides an ordering interface authoring tool using the realistic scene image contents via the market platform interface to the interior design business operator terminal (S1105).

Here, the ordering interface authoring tool may include an interface which may index and select product information to be registered on the market platform, and the realistic scene image contents corresponding to that from the interior design business operator terminal 500.

As aforementioned, the realistic scene image contents may be mapped with tag information corresponding to interior design products or styles arranged in the indoor space, so that the ordering interface authoring tool may provide a function of indexing one or more realistic scene image contents corresponding to product information inputted by the interior design business operator terminal 500 using the tag information and arranging them on the ordering interface. For example, if interior design construction product information inputted by the interior design business operator terminal 500 includes specific interior design product or style information and the like, it may index the realistic scene image contents including the specific interior design product or style information as the tag information and provide them via the ordering interface.

Further, the service providing device 100 registers interior design product information on the market platform interface according to ordering interface authoring data inputted from the interior design business operator terminal (S1107).

Thereafter, the service providing device 100 provides realistic scene image contents via the ordering interface of the interior design product information outputted from the consumer terminal 300 connected to the market platform (S1109).

Here, the realistic scene image contents may include tag information as aforementioned, and the consumer terminal 300 may confirm a detailed estimate of each tag information and the interior design product information and may input ordering information corresponding to that to the ordering interface.

Further, the service providing device 100 performs payment processing of ordering information inputted from the consumer terminal 300 (S1111) and provides priorly set rate or quantity of rewards to the user terminal 400 of the content manufacturer based on payment information (S1113).

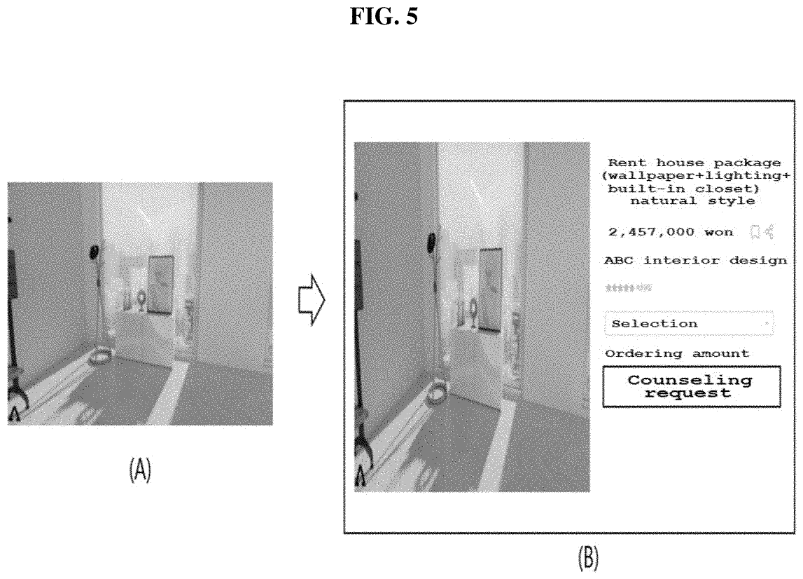

FIG. 5 is a view for describing realistic scene image-based market platform interface according to an example of the present disclosure.

As shown in FIG. 5(A), the content manufacturer terminal 400 may configure one or more realistic scene image contents in a distributed rendering method based on 3-dimensional virtual space interior design data according to an example of the present disclosure.

Further, as shown in FIG. 5(B), the configured realistic scene image contents may be processed as interior design product information in the interior design business operator terminal 500 and may be provided via the ordering interface.

Also, according to an example of the present disclosure, the ordering interface may be a general payment ordering interface or may include the ordering interface for interior design construction products as shown in FIG. 5(B).

Further, the service providing device 100 if a request for ordering or counseling corresponding to the ordering interface is confirmed, may pay rewards corresponding to manufacturer information of the content manufacturer terminal 400, and a rate or quantity of rewards may be determined according to at least one of the number of visitors, the number of like, an evaluation score, the number of favorite registration, ordering performance information or counseling performance information corresponding to the ordering interface.

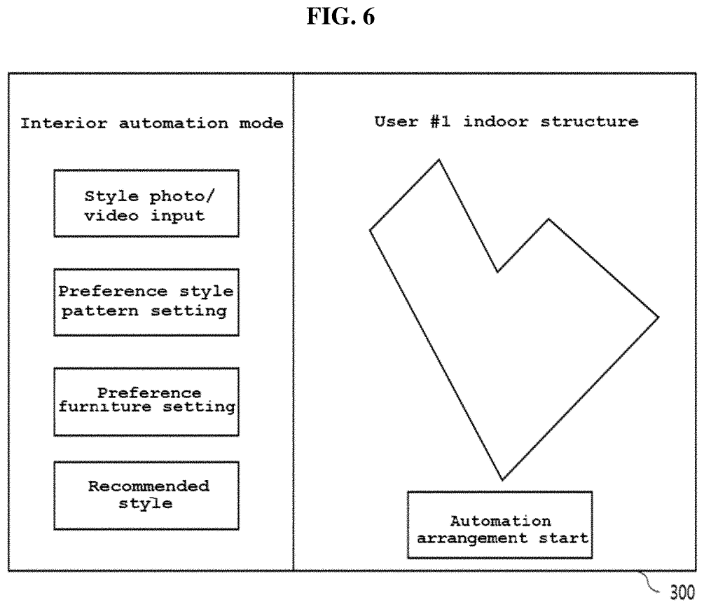

FIGS. 6 to 8 exemplify an indoor structure information interface outputted from a user terminal provided from the service providing device and outputted to the user terminal according to method implementation according to an example of the present disclosure.

Referring to FIG. 6, the service providing device 100 according to an example of the present disclosure may provide an interior design automation mode corresponding to indoor structure information of the user via the interface output portion 150 to the user terminals 300, 400, 500. The user may input desired style photo or video information as style-related information via the input portion of the user terminals 300, 400, 500, set a preference style pattern, set a specific preference furniture, or set and input to be provided with any preference style without additional setting, and input information of the user terminals 300, 400, 500 may be provided to the input portion 110 of the service providing device 100. Further, the user may make style analysis of the style information analysis portion 120 and layout generation processing of the layout generation processing portion 130 start via automatic arrangement button input according to an example of the present disclosure.

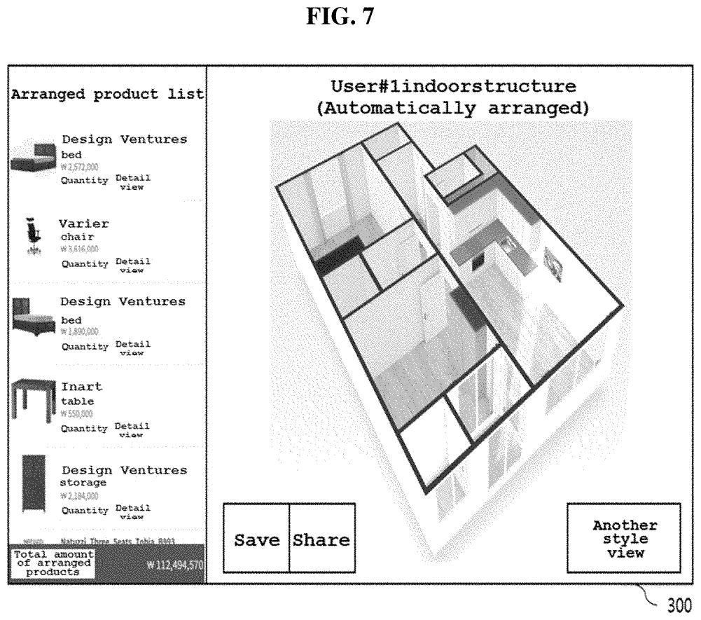

Further, referring to FIG. 7, FIG. 7 is a view for describing a layout automation result interface generated according to an example of the present disclosure, wherein an indoor structure interface in which a space layout and an interior design are automatically arranged is rendered and is outputted to the user terminals 300, 400, 500 via the interface output portion 160.

As shown in FIG. 7, the user may confirm a list of the arranged products and furniture information, and purchase information, may select to store or share the indoor structure information in which interior design automation is processed, or may request again to process automation by other styles. As the above, since interior design layout automation processing of the indoor structure according to style input of various users is possible, the user may write space and interior design information intuitively and conveniently without needs that the user makes a separate precise design or requests experts to work.

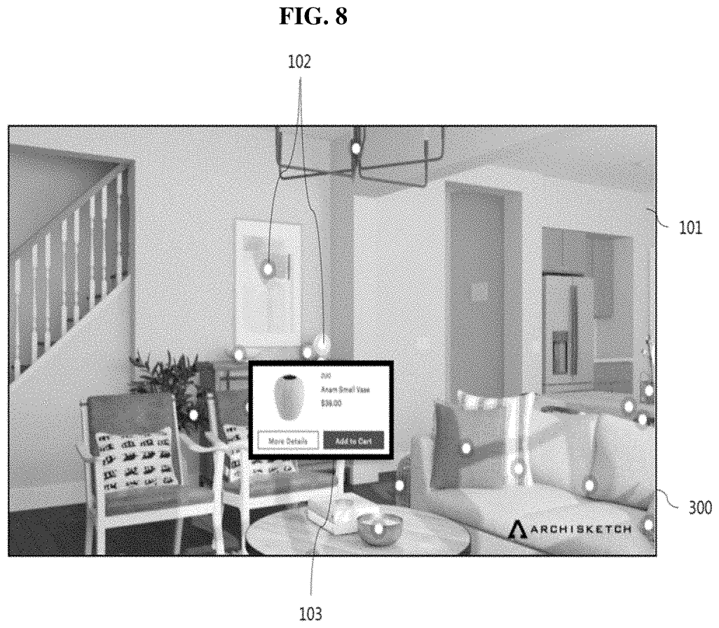

FIG. 8 is an illustrative view of a virtual space interior design display including the tag interface according to an example of the present disclosure.

As shown in FIG. 8, the service providing device 100 according to an example of the present disclosure may output a space and layout interface 101 rendered as a virtual space via the interface output portion 150 to the user terminals 300, 400, 500, wherein the aforementioned interfacing points 101 may be outputted on the space and layout interface. In FIG. 5, the interfacing points 101 are indicated as a circle arranged on an object but it may be also outputted as various forms such as a separate icon image, a square, a triangle, and a 3-dimensional object other than that.

In particular, the interfacing points according to an example of the present disclosure may be disposed at an optimized location not to duplicate and overlap with objects exposed on a user view area, and the user may select the user's desired interior design object comfortably without stress due to excessive object information identification.

Further, in case that the user performs pointing input such as a touch and a virtual touch corresponding to the interfacing points 101 through the user terminals 300, 400, 500, a tag interface 103 may be outputted. The tag interface 103 may be interlocked with various service functions such as object information, relevant content information, and purchase information provided from the service providing portion 170. Also, the service providing portion 170 may collect user selection input information and use it for user statistics analysis, recommended interior design provision, and the like later.

FIG. 9 is a block diagram which more specifically shows a space and interior design rendering portion according to an example of the present disclosure, and FIGS. 10 to 11 are illustrative views of realistic scene rendering processed images according to an example of the present disclosure.

As aforementioned, the rendering portion 160 according to an example of the present disclosure may distributedly render virtual space interior design contents provided to the user terminals 300, 400, 500 to realistic scene images using a cloud service network configured of the cloud device 200 and may construct a realistic scene image database corresponding to each viewpoint from the distributedly rendered partial rendering images in the storing portion 180.

Further, the rendering portion 160 may provide realistic scene images of 3-dimensional virtual space interior design contents corresponding to each viewpoint to the user terminals 300, 400, 500, according to a request of the control portion 140, the service providing portion 170 or the user terminals 300, 400, 500.

Here, the 3-dimensional virtual space interior design contents may include furniture contents priorly constructed in connection with the interior design, indoor space interior design contents written by the user or automation-constructed indoor space interior design contents. Further, the realistic scene image processing may include a global illumination-based rendering distributed process as aforementioned, and the rendering portion 160 may perform data optimization processing to effectively process computing resources in the global illumination-based rendering distributed process.

Also, the rendering portion 160 may perform object conversion processing which converts one or more first objects included in the realistic scene image to the second object according to a request of the user terminals 300, 400, 500 and may render the object-converted realistic scene image therefrom and provide it to the user terminals 300, 400, 500.

More specifically, referring to FIG. 9, the rendering portion 160 according to an example of the present disclosure includes a geometry information optimization portion 1601, a texel information optimization portion 1602, a transmission packet processing portion 1603, a realistic scene image configuration portion 1604, and an object conversion image reorganization portion 1605.

The geometry information optimization portion 1601 may perform geometry data optimization of scene images projected from the first viewpoint corresponding to the 3-dimensional virtual space interior design.

The geometry information optimization portion 1601 according to an example of the present disclosure indexes geometry data to be optimized for geometry data optimization, configures geometry data which may be processed as meta information among indexed geometry data as a meta information index, configures a geometry buffer including at least some of the indexed geometry data and the meta information index, and transfers it to the transmission packet processing portion 1603.

Further, the transmission packet processing portion 1603 packetizes geometry data corresponding to a geometry buffer and an index of the buffer and transfers it to one or more cloud devices 200.

In general, model data in a 3-dimensional graphic application may be mainly described as geometry data. However, referring to a pattern of the geometry data, it may be understood that a rate of data generated by an apex such as Vertex, normal, and face occupies about 45%-95% of the whole, and this is significantly greater than that of data generated by other instructions. Therefore, it may be understood that geometry data within transmission packets requested to be distributedly processed by the cloud device 200 has a duplication rate of average 35% to 61%.

Accordingly, the geometry information optimization portion 1601 according to an example of the present disclosure, as one method for reducing network traffic required for distributed processing using the cloud device 200, in case that geometry data similar with geometry data including apex information among data to be requested to be distributed is already present, processes meta information index mapping corresponding to that and processes to transfer only a meta information index. Thus, overall network bandwidth for constructing realistic scene image rendering processing as a cloud service may be reduced.

For example, the meta information index of the geometry data may include at least one of index information of geometry data to be transferred, location information corresponding to the index information, rotation information or a scale information index.

Accordingly, the cloud device 200 may distributedly perform photorealistic rendering processing such as global illumination-based ray tracing using the geometry data and meta information index, wherein a requirement of network bandwidth for this may be reduced.

Meanwhile, the texel information optimization portion 1602 may process optimization of texture pixel data (texel data) appearing such that a 3-dimensional object rendered by geometry data is projected on a 2-dimensional realistic scene image.

More specifically, the texel information optimization portion 1602 configures a Z buffer corresponding to texture data to be optimized for texture data optimization, processes to resize texture data according to a texture rate configured in the Z buffer, obtains texel information and memory area information to be used for rendering, indexes texture data to be processed to be resized according to memory area information and texel information, and configures a texture buffer.

The configured texture buffer therefrom may be transferred to the transmission packet processing portion 1603, and the transmission packet processing portion 1603 may packetize a texture buffer including indexing information of texture data to be processed to be resized and a request for rendering a texture data part including texture data to be processed to be resized and may transfer them to the cloud device 200.

Here, the Z-buffer is an image depth coordinate management method of 3-dimensional graphics and may mean a depth buffer where when 3-dimensional data is rendered to 2-dimensional scene images, depth information (z coordinate) of pixels configured by resizing is stored. This buffer may be aligned by each corresponding screen pixel element in a reference of a 2-dimensional coordinate of (x-y). If another object is to be rendered in the same pixel, the Z-buffer may be used for comparing depths about whether which one is closer to an observer between the present pixel and a pixel to be newly drawn.

With respect to this Z-buffer configuration process, various technical elements which are well known in the graphic processing field may be used, and according to the Z-buffer configuration, resizing information of texel information to be rendered and memory information used for rendering may be priorly obtained.

Accordingly, the texel information optimization portion 1602 according to an example of the present invention, in order to lower a duplication rate of data to be transferred to the cloud device 200, reduce capacity of the transmission packet, and enhance bandwidth efficiency, may configure a texture buffer including a texture data to be processed to be resized by the Z-buffer configuration process, index information of texture data to be processed to be resized, memory area information corresponding to texture data to be processed to be resized, and may transfer it to the transmission packet processing portion 1603.

Also, the texture buffer may include meta information mapped with index information of the texture data, and the meta information may include main texel information and representative color information. Here, the representative color information may include color information presenting an overall color sense of partial rendering-requested texture data, and the main texel information may include texture information assigned corresponding to a main object within a 3-dimensional virtual space to be substantially rendered.

As the above, according to a distributedly rendering-requested texture buffer configuration, the cloud device 200 when constructing rendering data, performs realistic scene image rendering for each texel corresponding to the main texel area and uniformly processes realistic scene image rendering using the representative color information with respect to the remaining areas. Thus, it may perform efficient data processing.

Also, according to the texture buffer configuration of the texel information optimization portion 1602, texture data included in the transmission packet is resized and indexed based on the Z-buffer configuration process, and thus, its transmission packet capacity may be reduced and the duplication utilization is reduced. Accordingly, the network bandwidth and utilization are reduced and it is possible to distributedly process realistic scene images efficiently.

Meanwhile, the realistic scene image configuration portion 1604 may receive partial scene images rendered in each cloud device 200 based on data transmitted from the transmission packet processing portion 1603 to the cloud device 200, combine and configure the received partial scene images to configure realistic scene images corresponding to the first viewpoint, store and manage them via the storing portion 140, and provide the priorly established realistic scene images according to a request of the user terminals 300, 400, 500. As aforementioned, the first viewpoint may be extended to a plurality of viewpoints, the realistic scene image according to an example of the present disclosure may be also provided as a plurality of realistic scene image contents in a form such as omnidirectional (720 degrees) realistic scene images or 360 degrees realistic scene images of a specific object.

The object conversion image reorganization portion 1605 may determine a partial conversion boundary area corresponding to an affected range by the object conversion corresponding to a first object before conversion and a second object after conversion, perform re-rendering processing of only the realistic scene image corresponding to the partial conversion boundary area, combine re-rendered scene image part with the remaining existing scene image part, and create a realistic scene image where the first object is converted to the second object. Thus, it may provide object conversion processing which may minimize operation quantity of a reoperation process and may also prevent occurrence of the sense of difference.

More specifically, the object conversion image reorganization portion 1605 may determine a conversion target first object of virtual space interior design contents corresponding to the first realistic scene image, and the first object may exemplify a furniture object with which the tag interface is mapped and the like.

Further, the object conversion image reorganization portion 1605 may set a first boundary area corresponding to the first object before conversion and a second boundary area corresponding to the second object after conversion. After incorporating the first boundary area and the second boundary area, it may determine a partial conversion boundary area according to a Convex Hull algorithm, so that the object conversion image reorganization portion 1605 may reorganize object-converted images via re-rendering processing corresponding to the partial conversion boundary area.

Here, the re-rendering processing may be performed in the object conversion image reorganization portion 1605 of the service providing device 100 but it may be preferably requested to one or more cloud devices 200 via the aforementioned geometry information optimization portion 1601, texel information optimization portion 1602, and transmission packet processing portion 1603 and may be distributedly processed.

More specifically, the object conversion image reorganization portion 1605 may obtain margin setting information for setting the first boundary area and the second boundary area, margin setting information of the first boundary area may correspond to a surrounding area range affected corresponding to the existing first object, and margin setting information of the second boundary area may correspond to a surrounding area range affected corresponding to the second object to be replaced. Each boundary area may have various shapes but a rectangular shape is preferable for processing efficiency enhancement.

Further, the object conversion image reorganization portion 1605 may determine an incorporation area where the first boundary area and the second boundary area are incorporated. Here, in case that the first boundary area is simply overlapped with the second boundary area, the incorporated area may not be formed in an overall connected form.

Accordingly, the object conversion image reorganization portion 1605 may determine an incorporated structure including one or more first intersecting points formed such that the first boundary area and the second boundary area intersect by applying the Convex Hull algorithm, wherein a partial conversion boundary area including the incorporated structure and the intersecting point may be determined.

Accordingly, the partial conversion boundary area may be an area where the first boundary area and the second boundary area are simply combined or an area formed by incorporation according to the Convex Hull algorithm. However, the object conversion image reorganization portion 1605 may generate the partial conversion boundary area, and distributed rendering request data using the second object information to be replaced, and may transfer them to one or more cloud devices 200.

Accordingly, a re-rendering area according to the selected specific first object and the second object to be replaced may be minimized, and throughput may be reduced, and thus bandwidth efficiency and network usability may be increased.

FIG. 10 is an illustrative view of realistic scene image processing corresponding to the indoor space structure interior design as virtual space interior design contents of the rendering portion 160 according to an example of the present disclosure.

As shown in the top of FIG. 10, the first viewpoint information and the global illumination information may be priorly set via the user terminals 300, 400, 500 or the service providing device 100.

Further, the virtual space interior design information may be formed of photographed realistic scene images as shown in the bottom of FIG. 7 according to distributed rendering processing based on the cloud device 200 of the rendering portion 160 corresponding to the set illumination information and viewpoint information and may be provided to the user terminals 300, 400, 500.

Also, FIG. 11 is an illustrative view of realistic scene image processing corresponding to the furniture interior design information as virtual space interior design contents of the rendering portion 160 according to an example of the present disclosure.

As shown in the left of FIG. 11, the furniture information to be rendered may be priorly set via the user terminals 300, 400, 500 or the service providing device 100.

Further, the virtual space interior design information including the furniture information may be formed of photographed realistic scene images as shown in the right of FIG. 11 according to distributed rendering processing based on the cloud device 200 of the rendering portion 160 and may be provided to the user terminals 300, 400, 500.

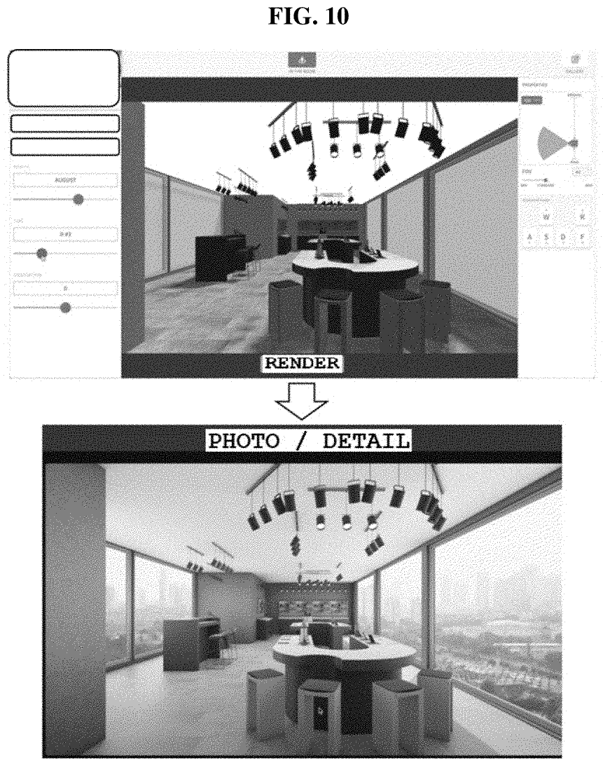

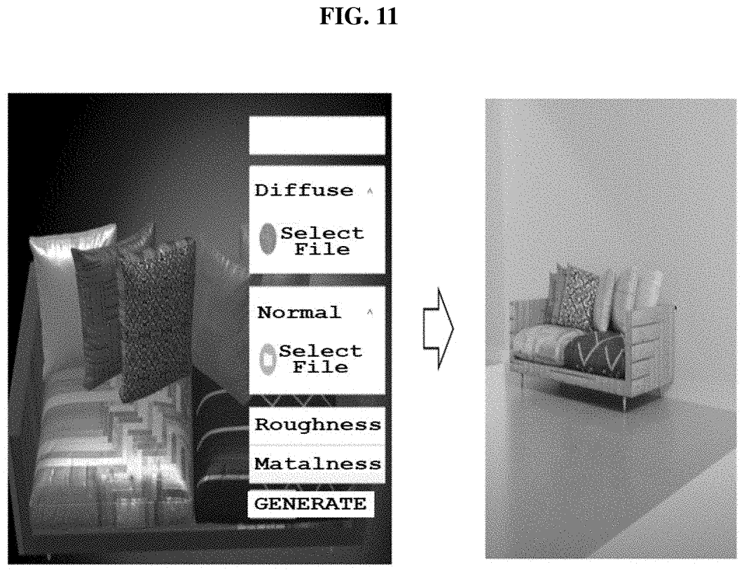

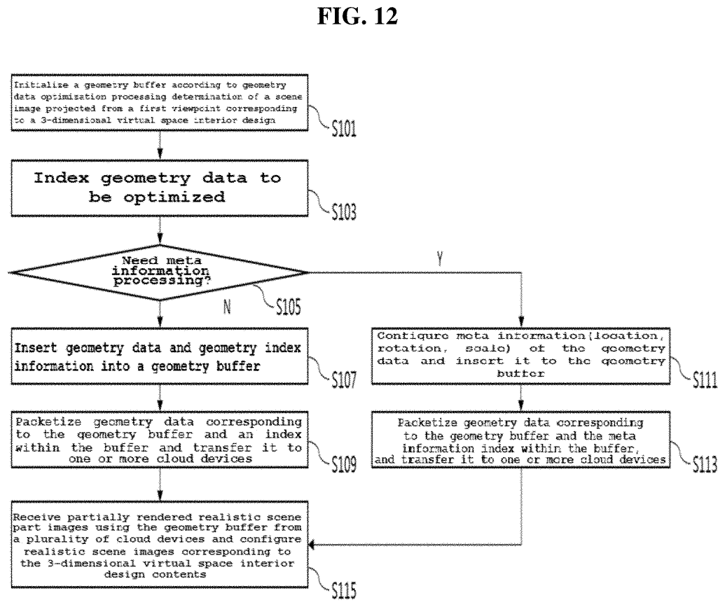

FIGS. 12 to 14 are flow charts for more specifically describing operations of the rendering portion according to an example of the present disclosure.

In advance, FIG. 12 is a first flow chart for describing operations of the rendering portion 160 of the service providing device 100 according to an example of the present disclosure, wherein the service providing device 100 initializes a geometry buffer according to geometry data optimization processing determination of scene images projected from the first viewpoint corresponding to 3-dimensional virtual space interior design (S101).

Further, the service providing device 100 indexes geometry data (for example, a vertex data) to be optimized (S103), and determines whether processing of meta information corresponding to geometry data is needed (S105).

Here, whether to process meta information may be determined according to whether the same or similar geometry data to be included within the geometry buffer is present, whether bandwidth is reduced, whether a compression rate is increased or reduced, and the like. If the same or similar geometry data is not present, the service providing device 100 inserts geometry data and indexes information corresponding to the geometry data to the geometry buffer without processing meta information (S107), packetizes geometry data corresponding to the geometry buffer and an index within the buffer and transfers it to one or more cloud devices (S109).

Meanwhile, if meta information processing is needed, the service providing device 100 configures meta information (location information, rotation information, scale information) of the geometry data as a meta information index, inserts it to the geometry buffer (S111), packetizes geometry data corresponding to the geometry buffer and the meta information index within the buffer, and transfers it to one or more cloud devices (S113).

Thereafter, the service providing device 100 receives partially rendered realistic scene part images using the geometry buffer from a plurality of cloud devices 200 and configures realistic scene images corresponding to the 3-dimensional virtual space interior design contents (S115).

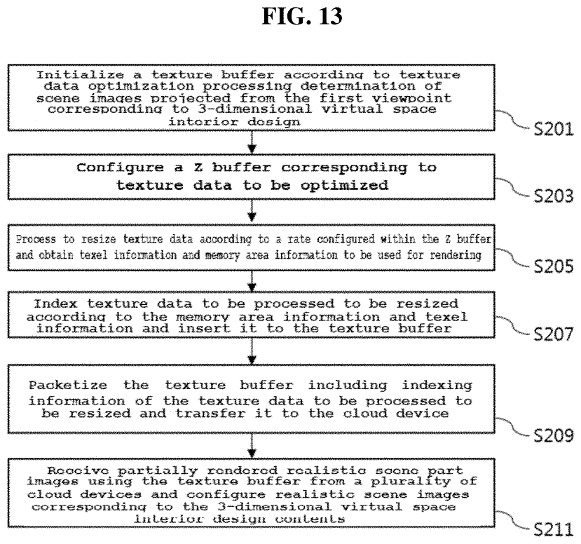

Further, FIG. 13 is a second flow chart for describing operations of the rendering portion 160 of the service providing device 100 according to an example of the present disclosure, wherein the service providing device 100 initializes a texture buffer according to texture data optimization processing determination of scene images projected from the first viewpoint corresponding to 3-dimensional virtual space interior design (S201).

Further, the service providing device 100 configures a Z buffer corresponding to texture data to be optimized (S203).

Thereafter, the service providing device 100 processes to resize texture data according to a rate configured within the Z buffer and obtains texel information and memory area information to be used for rendering (S05).

Further, the service providing device 100 indexes texture data to be processed to be resized according to the memory area information and texel information and inserts it to the texture buffer (S207).

Thereafter, the service providing device 100 packetizes the texture buffer including indexing information of the texture data to be processed to be resized and transfers it to the cloud device 200 (209).

Further, the service providing device 100 receives partially rendered realistic scene part images using the texture buffer and configures realistic scene images corresponding to the 3-dimensional virtual space interior design contents (S211).

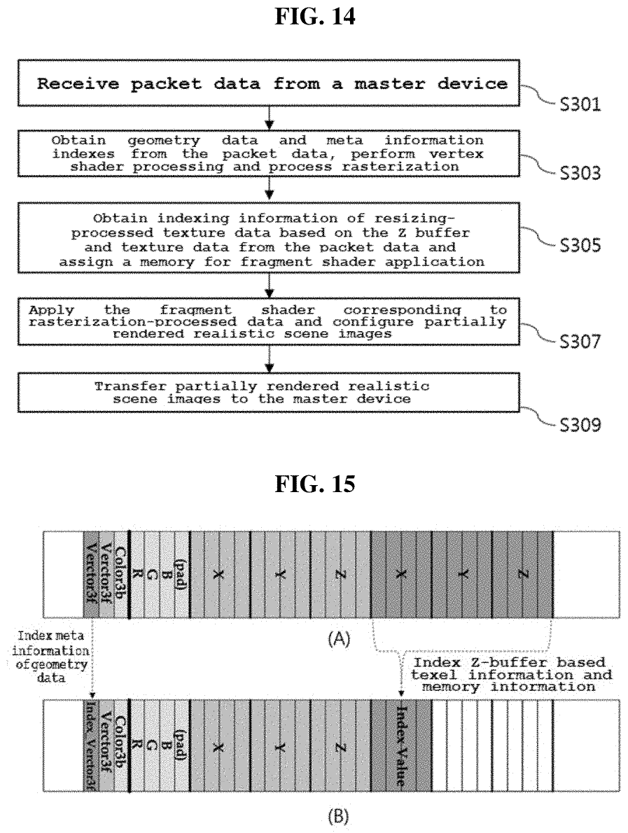

Meanwhile, FIG. 14 is a flow chart for describing operations of the cloud device 200 according to an example of the present disclosure.

Referring to FIG. 14, the cloud device 200 receives packet data for distributed rendering from the service providing device 100 that is a master device (S301).

Further, the cloud device 200 obtains geometry data and meta information indexes from the packet data in advance, and performs vertex shader processing and rasterizer processing (S303).

Further, the cloud device 200 obtains indexing information of resizing-processed texture data based on the Z buffer and texture data from the packet data and assigns a memory for fragment shader application (S305).

Thereafter, the cloud device 200 applies the fragment shader corresponding to rasterized processed data, determines a rasterized pixel value, and thus configures partially rendered realistic scene images (S307).

Further, the cloud device 200 transfers partially rendered realistic scene images to the service providing device 100 that is the master device (S309).

Here, the cloud device 200 may perform a process in various global illumination methods for granting actual image effects in shading processing of each step, the global illumination method may preferably exemplify a ray tracing method of reversely tracing rays. However, furthermore, methods such as path tracing, photon mapping, and radiosity may be also added.

FIG. 15 is a view for describing a transmission packet structure configured in the rendering portion 160 according to an example of the present disclosure.

FIG. 15(A) shows a data structure before optimization, wherein geometry data such as Vector3f and texture data such as X, Y, Z may be present by overlapping on whole original 3-dimensional data.

Accordingly, the rendering portion 160 according to an example of the present disclosure may perform indexing processing of geometry meta information via a geometry information optimization portion 1601, process texel information and memory information indexing based on the Z buffer via a texel information optimization portion 1602, and configure optimized transmission packet data as shown in FIG. 12(B).

According to data optimization processing of this service providing device 100, a realistic scene data configuration based on the cloud service network is possible, quality of the realistic scene image provided to the user terminal 300, 400, 500 may be enhanced, processing time may be reduced, and the network bandwidth may be reduced. Thus, overall service efficiency may be enhanced.

FIGS. 16 to 20 are views for more specifically describing object conversion operations of the rendering portion according to an example of the present disclosure.

In advance, referring to FIG. 16, the object conversion image reorganization portion 1605 sets a conversion object of virtual space interior design contents corresponding to first realistic scene images (S401).

Further, the object conversion image reorganization portion 1605 sets a first boundary area corresponding to a first object before conversion (S403).

Thereafter, the object conversion image reorganization portion 1605 sets a second boundary area corresponding to a second object after conversion (S405).

Further, the object conversion image reorganization portion 1605 after incorporating the first boundary area and the second boundary area, determines a partial conversion boundary area according to the Convex Hull algorithm.

Thereafter, the object conversion image reorganization portion 1605 performs re-rendering processing corresponding to the partial conversion boundary area (S409), combines a re-rendered scene image part and the remaining existing image part of the first realistic scene images, and generates converted realistic scene images (S411).

Further, the object conversion image reorganization portion 1605 stores and manages converted realistic scene images as a second object-converted second realistic scene images with respect to the first object (S413).

Thereafter, the object conversion image reorganization portion 1605 provides a conversion service using the priorly converted second realistic scene image via a service providing portion 170 to the user terminals 300, 400, 500 according to a request for object replacement within images (S415).

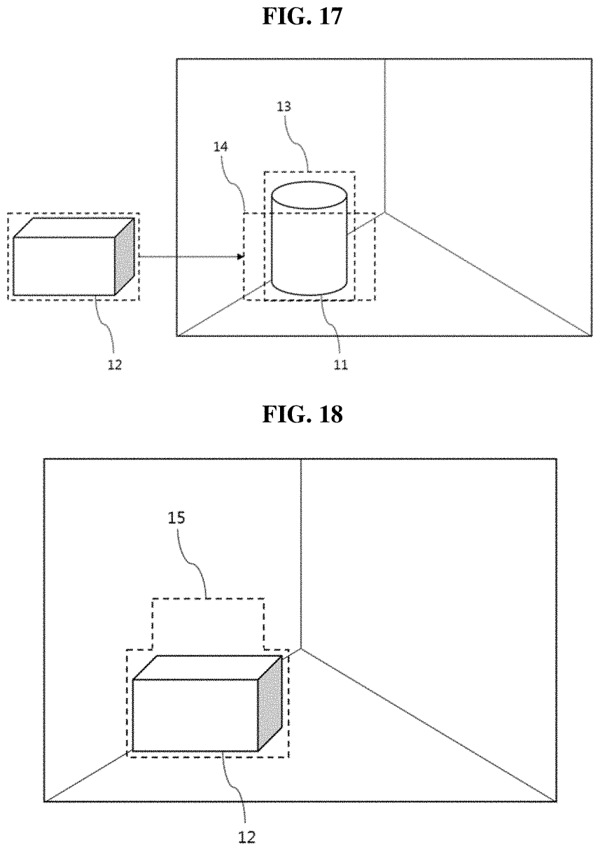

Here, referring to FIG. 17, FIG. 17 represents a boundary area to change a first object 13 before conversion to a second object 12 after conversion, respectively. Referring to FIG. 17, the first boundary area 13 and the second boundary area 14 may be differently determined according to a form or shape of each object 11, 12.

Further, referring to FIG. 18, the object conversion image reorganization portion 1605 according to an example of the present disclosure may form an incorporated area 15 where the first boundary area 13 and the second boundary area 14 are incorporated.

As this incorporated area 15 is formed, an object range which substantially affects when configuring realistic scene images may be set.

Meanwhile, the object range is preferably polygonal, so that it is preferable that it should be set by a convex hull area-incorporated area 15 for configuring a polygon.

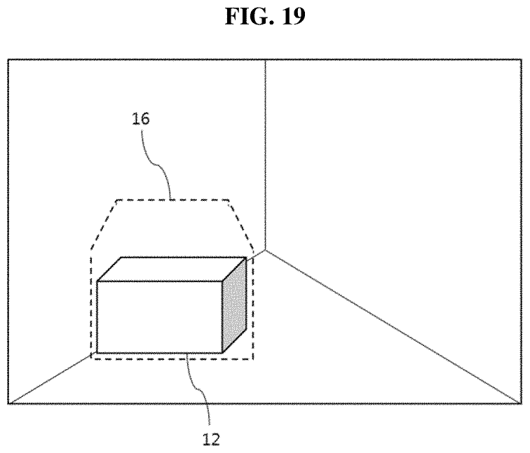

Further, as showing in FIG. 19, the convex hull area when some of dots (nodes) forming the polygon are connected, may mean a convex polygonal area configured to include all the remaining nodes. In order to determine the convex hull area, various general algorithms may be used and a Graham's scan method which may be performed within O(n) hour according to alignment of nodes may be exemplified.

This is a method of configuring lists that edges of nodes are aligned in the order of a clockwise direction or a counterclockwise direction, sequentially indexing each node in a clockwise direction or a counterclockwise direction, and determining whether it is a node configuring the convex hull according to whether it is included within the convex hull area.

Accordingly, FIG. 19 presents that the determined incorporated area 15 is determined according to the convex hull algorithm.

Further, the object conversion image reorganization portion 1605 may determine the incorporation area 15 as a partial conversion boundary area. The object conversion image reorganization portion 1605 may reorganize object-converted realistic scene images via re-rendering processing corresponding to the partial conversion boundary area without a separate whole image rendering.

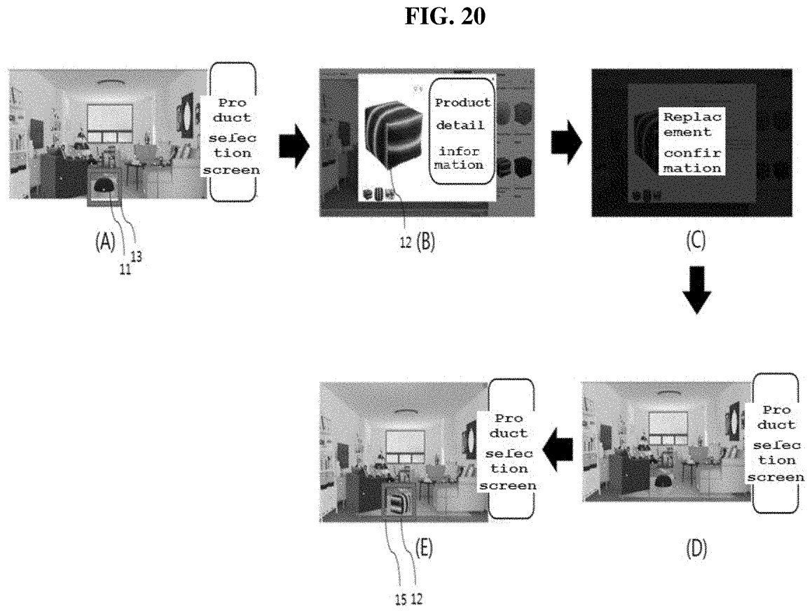

FIG. 20 is illustrative views of an interface screen of the user terminals 300, 400, 500 according to re-rendering processing of the object conversion image reorganization portion 1605 according to an example of the present disclosure.

As shown in FIG. 20(A), the user of the user terminals 300, 400, 500 may select the first object 11 to be replaced on the realistic scene image-rendered virtual space interior design image and the service providing device 100 may determine the first boundary area 13 corresponding to that in a rectangular form.

Further, as shown in FIG. 20(B), the user may select the second object information. For example, the second object 12 may exemplify a replaceable furniture interior design such as a chair and sofa, and relevant 3-dimensional object information may be priorly stored in the storing portion 140.

Thereafter, as shown in FIG. 20(C), if replacement confirmation input is received, the service providing device 100 may process only re-rendering corresponding to the partial conversion boundary area 15 as shown in FIG. 20(E) among the realistic scene image-rendered first images as shown in 20 (D), and may output the second realistic scene image including the second object 12 priorly established by incorporating into the remaining area which is not re-rendered to the user terminals 300, 400, 500.

According to processing as the above, even if the object is changed, rendering with high complexity such as global illumination rendering for each object conversion is not wholly processed again and is partially processed and incorporated, so that efficiency may be enhanced. A partial conversion boundary area configuration not to reduce the sense of difference and reality is possible, so that natural object conversion service processing may be provided.

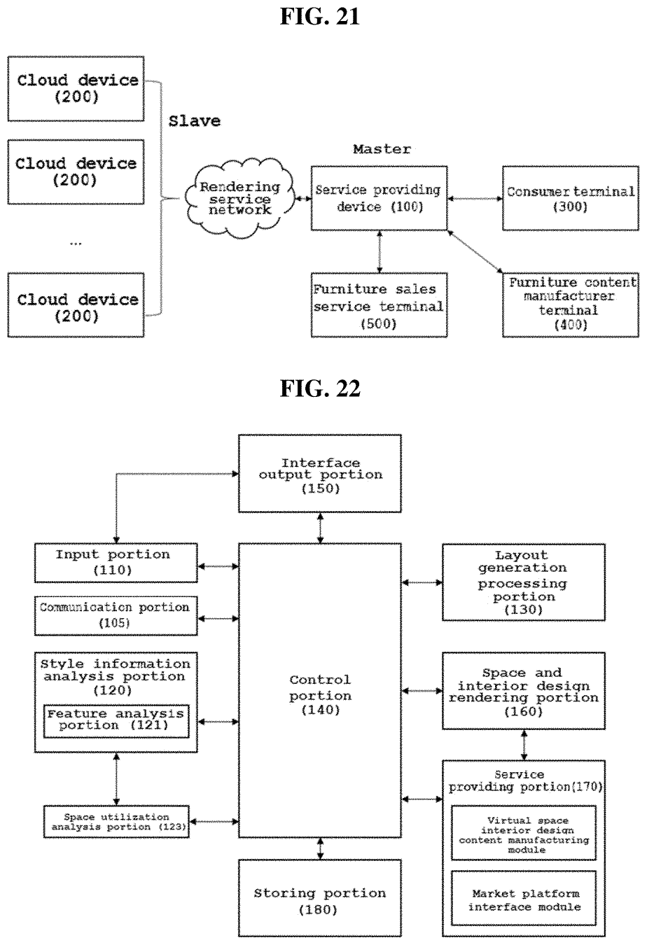

FIG. 21 is a view for schematically describing a whole system according to a second example of the present disclosure.

Referring to FIG. 21, the whole system according to the second example of the present disclosure includes the service providing device 100, one or more cloud device 200, the consumer terminal 300, and a furniture sales service terminal 500 and selectively includes a furniture content manufacturer terminal 400, or the furniture sales service terminal 500 may perform a function of the furniture content manufacturer terminal 400.

In advance, the consumer terminal 300, the furniture content manufacturer terminal 400, and the furniture sales service terminal 500 described in the specification may be commonly referred to as user terminals 300, 400, 500 according to a general function. In advance, this general function is described. An operation of each terminal is the same as that described in FIG. 1 and thus, it is omitted.

Further, the furniture sales service terminal 500 may be a user terminal of a business operator who provides a furniture sales service, wherein it may manufacture and register realistic scene image contents corresponding to a furniture item in the service providing device 100, generate an ordering interface including furniture product information to be sold and request the service providing device 100 to register the generated ordering interface. The ordering interface requested to be registered may be registered on a furniture sales market platform interface provided by the service providing device 100.

Here, the furniture product information to be sold may include one or more realistic scene image contents corresponding to the furniture item, include a plurality of realistic scene images rendered respectively according to a plurality of viewpoint angles corresponding to the 3-dimensional furniture data. For the above, the service providing device 100 may combine the plurality of realistic scene images according to the plurality of viewpoint angles and configure realistic scene image contents corresponding to the furniture item.

Also, for example, the realistic scene image contents may process to convert a specific furniture object area of virtual space interior design contents obtained from one or more user terminals 300, 400, 500 to realistic scene images corresponding to the furniture item and configure the realistic scene image contents.

Also, if the ordering interface according to this is recorded on the furniture sales market interface, the service providing device 100 may pay each fee or rewards corresponding to the fees to a furniture content manufacturer and a manufacturer of the virtual space interior design contents.

For example, the service providing device 100 may provide a priorly set rate or quantity of rewards to a user terminal account providing the virtual space interior design contents according to ordering information input of the ordering interface corresponding to the furniture product information. Here, the priorly set rate or quantity of the rewards may be determined according to evaluation information of the realistic scene image collected via the furniture sales market platform interface corresponding to the furniture product information.

Accordingly, the service providing device 100 may provide the furniture product information including the realistic scene image contents to one or more consumer terminals 300 connected to the market platform interface.

Also, the service providing device 100 may collect ordering information inputted via the ordering interface corresponding to the furniture product information from the consumer terminal 300 and may perform payment processing.

By the process as the above, the service providing device 100 may make the furniture sales service terminal 500 generate the ordering interface which includes furniture product information with low costs and high quality using realistic scene images corresponding to a furniture item configured by various furniture content manufacturer terminals 400 or furniture sales service terminals 500 and may receive ordering information of the consumer terminal 300 with respect to this ordering interface and may process payment. Thus, the furniture sales market platform may be provided more efficiently and with few costs.

Detailed components of each device to realize the second example are more specifically described with reference to FIG. 22.

With reference to FIG. 22, the service providing device 100 includes a communication portion 105, an input portion 110, a style information analysis portion 120, a layout generation processing portion 130, a control portion 140, an interface output portion 150, a space and interior design rendering portion 160, a service providing portion 170, and a storing portion 180. Since components shown in FIG. 22 are not necessary, a terminal having more components or fewer components than them may be realized.

This is wholly similar with that shown in FIG. 2 as aforementioned, and thus the description is omitted with respect to parts of which operations are the same.

The service providing portion 170 may include a market platform interface module for processing a furniture sales market platform service and ordering information and may include a virtual space interior design content manufacturing module for supporting to manufacture and register realistic scene image contents for each furniture item to be used in the furniture sales market platform interface module.

For example, the service providing portion 170 may make the content manufacturer terminal 400 manufacture realistic scene image contents including furniture information for interior design arrangement, a purchase link, and the like using a virtual space interior design content manufacturing module and may obtain manufacturer and seller information and may register matching on the database of the storing portion 180.

Also, for example, the service providing portion 170 may output one or more of furniture information tagging interfaces included in video images in which the interior design layout automation information rendered via the interface output portion 150 to the user terminals 300, 400, 500 and may process a service of providing the furniture information and purchase link according to user input corresponding to the tagging interface.

Accordingly, the user not only may be provided with the automated interior design layout service but also may check detailed information of furniture and purchase information for actually applying to the user's indoor space directly.

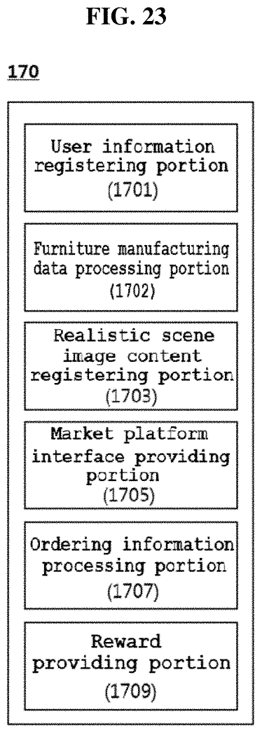

FIG. 23 is a block diagram for more specifically describing a service providing portion according to the second example of the present disclosure.

Referring to FIG. 23, the service providing portion 170 according to an example of the present disclosure includes a user information registering portion 1701, a realistic scene image content registering portion 1703, a market platform interface providing portion 1705, an ordering information processing portion 1707, and a reward providing portion 1709.

The user information registering portion 1701 may receive user information of each of the consumer terminal 300, the furniture content manufacturer terminal 400, and the furniture sales service terminal 500 and may process to priorly store and register in the storing portion 180.

Further, a furniture manufacturing data processing portion 1702 may receive furniture item data inputted from the furniture content manufacturer terminal 400 or the furniture sales service terminal 500 and configure it as 3-dimensional virtual space data. Here, the furniture item data may be 3-dimensional data or include a plurality of image data, and the 3-dimensional virtual space data may include 3-dimensional profile coordinates and texture information of the furniture item.

Further, the realistic scene image content registering portion 1703 may process distributed rendering based on furniture item data according to a request of the furniture sales service terminal 500, may configure one or more realistic scene image contents, may match the one or more realistic scene image contents to manufacturer and seller information, and may process to store and register them in the database of the storing portion 180.

Further, the market platform interface providing portion 1705 may provide a furniture sales interface authoring service using the realistic scene image to the furniture sales service terminal 500 and may process to register furniture product information based on authoring data inputted from the furniture sales service terminal 500, on the furniture sales market platform interface. The registered product information may be shared with one or more consumer terminals 300.

Accordingly, the market platform interface providing portion 1705 may provide the furniture product information to the consumer terminal 300 via the furniture sales market platform interface. Here, the furniture product information may include the aforementioned realistic scene image contents.

Further, the ordering information processing portion 1707 performs confirmation and payment processing of ordering information inputted from the consumer terminal 300. Further, the ordering information processing portion 1707 may have one or more ordering payment module (not shown) to support ordering information and payment processing of the consumer terminal 300, wherein payment information may be transferred to the reward providing portion 1709.

Further, the reward providing portion 1709 may provide or pay a priorly set rate or quantity of rewards corresponding to manufacturer information of the virtual space interior design contents to an account corresponding to the manufacturer information if the realistic scene image applied to the furniture product information includes the virtual space interior design contents.

Further, the priorly set rate or quantity of the rewards may be determined in various ways.

For example, the priorly set rate or quantity of the rewards may be determined according to evaluation information of the realistic scene image collected via the furniture sales market platform interface corresponding to the furniture product information. The evaluation information may exemplify the number of searching, a rating value, the number of selecting like, and the like.

Also, the reward providing portion 1709 may receive not only rewards with respect to ordering payment but also content fees from the furniture sales service terminal if the furniture product information is registered on the furniture sales market platform interface and may transfer them to the user account corresponding to the manufacturer information.

Thanks to processing as the above, the realistic interior design scene image based on 3-dimensional furniture item data may be easily configured, and it is possible to provide the furniture sales market platform interface based on the configured realistic scene image contents. Accordingly, ordering interface creation of the furniture product information based on the competitive realistic furniture item scene image is easily processed without needs of excessive human resources.

Also, the manufacturer information in connection with this realistic scene image contents is registered and managed, so that it is possible to impose usage fees of the furniture seller or provide rewards according to reward setting. Thus, participation of the content manufacturers may be increased and the market platform service may be activated.

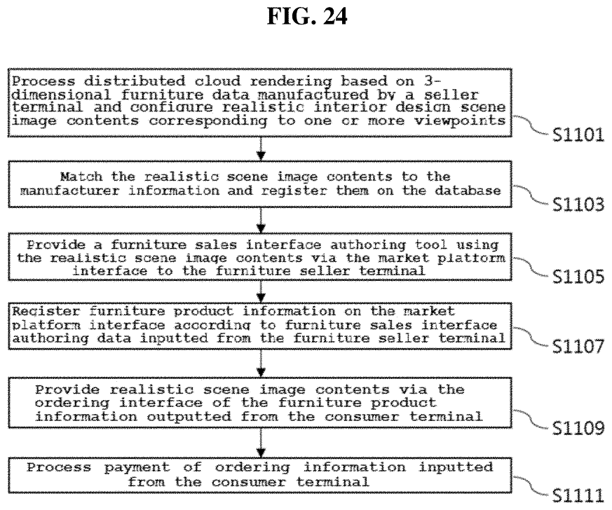

FIG. 24 is a flow chart for more specifically describing a service providing method according to the second example of the present disclosure.

Referring to FIG. 24, the service providing device 100 according to an example of the present disclosure processes distributed cloud rendering based on 3-dimensional furniture data manufactured by a seller terminal and configures realistic interior design scene image contents corresponding to one or more viewpoints (S1101).

Further, the service providing device 100 matches the realistic scene image contents to seller information and registers them on the database of the storing portion 180 (S1103).

Further, the service providing device 100 provides an ordering interface authoring tool using the realistic scene image contents via the market platform interface to the furniture sales service terminal 500 (S1105).

Here, the ordering interface authoring tool may include an interface which may index and select product information to be registered on the furniture sales market platform, and the realistic scene image contents corresponding to that from the furniture sales service terminal 500.

Further, the service providing device 100 registers interior design product information on the market platform interface according to ordering interface authoring data inputted from furniture sales service terminal 500 (S1107).

Thereafter, the service providing device 100 provides realistic scene image contents via the ordering interface of the interior design product information outputted from the consumer terminal 300 connected to the market platform (S1109).

Here, the realistic scene image contents may include a plurality of realistic scene images corresponding to a plurality viewpoint angels, and the consumer terminal 300 may confirm a detailed form of the furniture product information according to each viewpoint angle, interior design suitability, and the like and may input ordering information corresponding to that to the ordering interface.

Further, the service providing portion 100 performs payment processing of ordering information inputted from the consumer terminal 300 (S1111).

If realistic scene image contents include virtual space interior design contents manufactured in other user terminals, the service providing portion 100 may also provide a priorly set rate or quantity of rewards to the user terminal of the furniture content manufacturer.

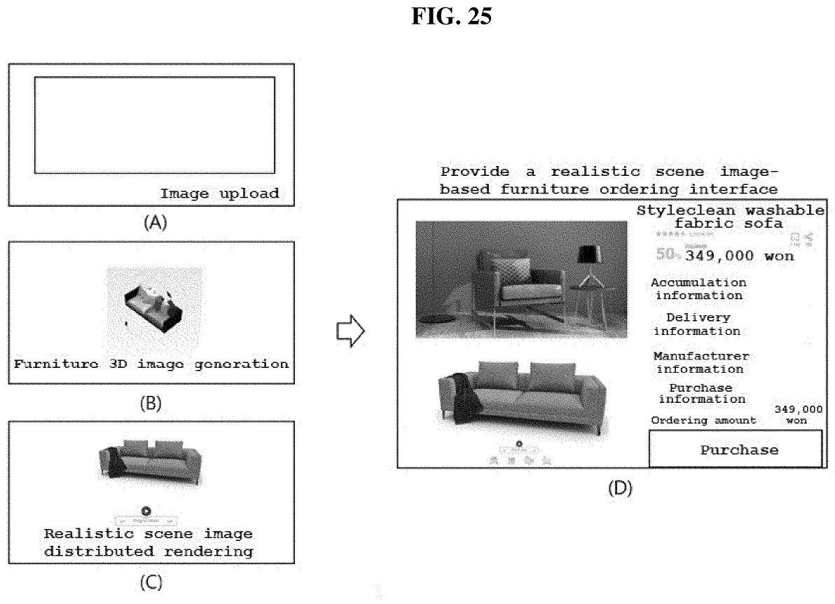

FIG. 25 is a view for describing a realistic scene image-based market platform interface according to the second example of the present disclosure.

As shown in FIG. 25(A), the furniture sales service terminal 500 or the furniture content manufacturer terminal 400 may input furniture item data according to an example of the present disclosure via the furniture item manufacturing interface provided by the service providing portion 100 in an image upload method, and as shown in FIG. 25(B), 3-dimensional image-based furniture data may be constructed via a 3-dimensional data template.

Further, as shown in FIG. 25(C), a space and interior design rendering portion 160 of the service providing portion 100 may generate realistic scene image contents according to each viewpoint direction via distributed rendering processing of the realistic scene images. Here, the viewpoint angle may be subdivided in a level that 720 degrees rotation is possible, the distributed rendering data of the realistic scene image may be used as rotatable 3-dimensional object data rendered on an augmented reality display or a virtual reality display.

Further, as shown in FIG. 25(D), the configured realistic scene image contents may be processed as furniture product information in the furniture sales service terminal 500 and may be provided via the ordering interface.

Also, according to an example of the present disclosure, the ordering interface may be provided with not only realistic scene image contents of the furniture item itself but also realistic scene image contents in a form combined with surrounding virtual space interior design contents, so that this may be rendering-processed by the object conversion method and may be outputted to the ordering interface.

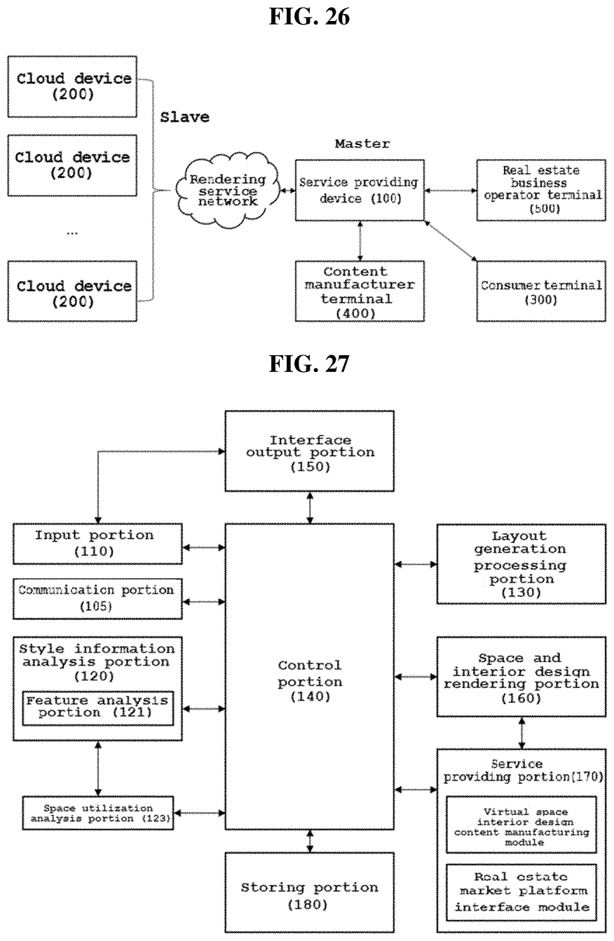

FIGS. 26 to 30 are views for describing a system and an operation according to a third example of the present disclosure.

FIG. 26 is a view for schematically describing a whole system according to a third example of the present disclosure.

With reference to FIG. 26, a whole system according to the third example of the present disclosure includes a service providing device 100, one or more cloud devices 200, a consumer terminal 300, a content manufacturer terminal 400, and a real estate business operator terminal 500.

In advance, the consumer terminal 300, the content manufacturer terminal 400, and the real estate business operator terminal 500 described in the specification may be commonly referred to as user terminals 300, 400, 500 according to a general function. In advance, this general function and an operation of each terminal are specifically described in FIG. 1, and thus the description thereof is omitted.

The real estate business operator terminal 500 may be a user terminal of a business operator who provides interior design products and services and may generate a brokerage interface including product information to be sold using realistic scene image contents registered on the service providing device 100 and may request the service providing device 100 to register the generated brokerage interface. The brokerage interface requested to be registered may be registered on an interior design-related market platform interface provided by the service providing device 100.

For example, the product information to be sold may include an interior design construction product and the realistic scene image contents may be provided as a construction sample image of the interior design construction product. Further, in order to generate the brokerage interface, the service providing device 100 may provide a brokerage interface authoring service including the construction sample image to the real estate business operator terminal 500 and may register real estate product information based on authoring data inputted from the real estate business operator terminal 500, on a real estate market platform interface.

Accordingly, the service providing device 100 may provide the real estate product information including the realistic scene image contents to one or more consumer terminals 300 connected to the market platform interface. The service providing device 100 may collect real estate brokerage request information inputted via the real estate brokerage interface corresponding to the real estate product information from the consumer terminal 300 and may perform brokerage processing.

By the process as the above, the service providing device 100 may make the real estate business operator terminal 500 generate the brokerage interface which includes real estate product information with low costs and high quality using realistic scene images configured by various content manufacturer terminals 400 and may receive brokerage request information of the consumer terminal 300 with respect to this brokerage interface and may process payment. Thus, the real estate market platform may be provided more efficiently and with few costs.

Also, manufacturer information of the content manufacturer terminal 400 may be used for calculating rewards corresponding to the realistic scene image. For example, in case that inquiries and payment processing of the real estate product information are completed or are registered on the market platform interface, the service providing device 100 may calculate rewards with respect to use of the realistic scene image and pay or provide the rewards corresponding to the manufacturer information.

Detailed components of each device to realize the above are more specifically described with reference to FIG. 27.

With reference to FIG. 27, the service providing device 100 includes a communication portion 105, an input portion 110, a style information analysis portion 120, a layout generation processing portion 130, a control portion 140, an interface output portion 150, a space and interior design rendering portion 160, a service providing portion 170, and a storing portion 180. Since components shown in FIG. 27 are not necessary, a terminal having more components or fewer components than that may be realized. Also, the whole system is similar with a configuration of FIG. 2, and thus the description with respect to the element having the same function with that of the described part is omitted.

The service providing portion 170 may include a market platform interface module for processing a market platform service and brokerage request information and may include a virtual space interior design content manufacturing module for supporting to manufacture and register realistic scene image contents to be used in the market platform interface module.

For example, the service providing portion 170 may make the content manufacturer terminal 400 manufacture realistic scene image contents including furniture information used for interior design arrangement, a purchase link, and the like using the virtual space interior design content manufacturing module, obtain manufacturer information and register matching on the database of the storing portion 180.

Also, for example, the service providing portion 170 may output a tagging interface of one or more of furniture information included in video images in which the interior design layout automation information is rendered via the interface output portion 150 to the user terminals 300, 400, 500 and may process a service of providing the furniture information and purchase link according to user input corresponding to the tagging interface.

Accordingly, the user not only may be provided with the automated interior design layout service but also may check detailed information and purchase information of furniture for actually applying it to the user's indoor space directly.

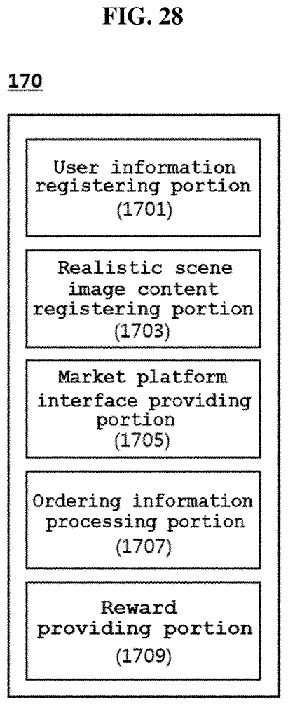

FIG. 28 is a block diagram for more specifically describing a service providing portion according to an example of the present disclosure.

Referring to FIG. 28, the service providing portion 170 according to an example of the present disclosure includes a user information registering portion 1701, a realistic scene image content registering portion 1703, a market platform interface providing portion 1705, a brokerage ordering information processing portion 1707, and a reward providing portion 1709.

The user information registering portion 1701 may receive user information of each of the consumer terminal 300, the content manufacturer terminal 400, and the real estate business operator terminal 500 and may process to priorly store and register it in the storing portion 180.

Further, the realistic scene image content registering portion 1703 may process distributed rendering based on virtual space content data manufactured by one or more user terminals according to a request of the content manufacturer terminal 400, configure one or more realistic scene image contents, match the one or more realistic scene image contents to manufacturer information, and process to store and register them in the database of the storing portion 180.

Further, the market platform interface providing portion 1705 may provide a brokerage interface authoring service using the realistic scene image to the real estate business operator terminal 500 and may process to register real estate product information based on authoring data inputted from the real estate business operator terminal 500, on the real estate market platform interface. The registered product information may be shared with one or more consumer terminals 300.

Accordingly, the market platform interface providing portion 1705 may provide the real estate product information to the consumer terminal 300 via the real estate market platform interface. Here, the real estate product information may include the aforementioned realistic scene image contents.

Further, the brokerage ordering information processing portion 1707 performs confirmation and relevant information processing of brokerage request information inputted from the consumer terminal 300. The brokerage ordering information processing portion 1707 may have one or more brokerage modules (not shown) to support real estate transaction brokerage information corresponding to a brokerage request of the consumer terminal 300 and relevant interior design company recommendation processing, wherein brokerage information may be transferred to the reward providing portion 1709.

Further, the reward providing portion 1709 may provide or pay a priorly set rate or quantity rewards corresponding to manufacturer information of the realistic scene image applied to the real estate product information according to brokerage information to an account corresponding to the manufacturer information.

Further, the priorly set rate or quantity of the rewards may be determined in various ways.

For example, the priorly set rate or quantity of the rewards may be determined according to evaluation information of the realistic scene image collected via the real estate market platform interface corresponding to the real estate product information. The evaluation information may exemplify the number of searching, a rating value, the number of selecting like, and the like.

Also, the reward providing portion 1709 may receive not only rewards with respect to real estate brokerage information but also content fees from the real estate business operator terminal 500 if the real estate product information is registered on the real estate market platform interface and may transfer them to the user account corresponding to the manufacturer information.

Thanks to processing as the above, the realistic interior design scene image based on establishment of 3-dimensional indoor space data of each user may be easily configured, and it is possible to provide the market platform interface based on the configured realistic scene image contents. Accordingly, brokerage interface creation of the real estate product information based on the competitive realistic interior design scene image is easily processed without needs of excessive human resources.

Also, the manufacturer information of these realistic interior design scene image contents is registered, so that it is possible to provide rewards according to fee charging or reward setting of the real estate business operator. Thus, participation of the content manufacturers may be increased and the market platform service may be activated.

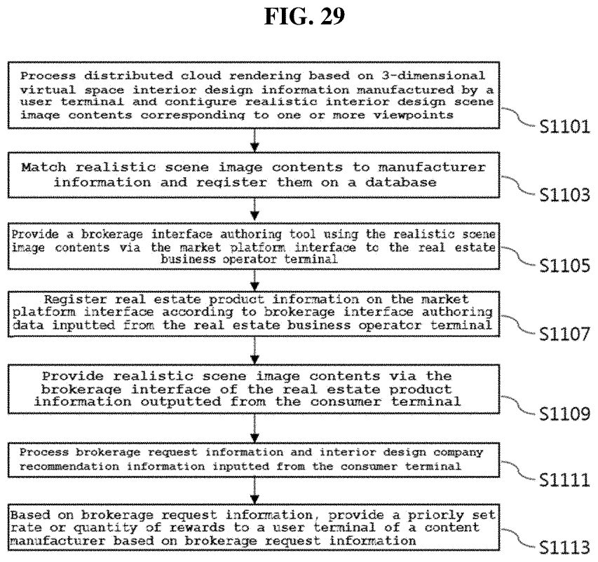

FIG. 29 is a flow chart for more specifically describing a service providing method according to an example of the present disclosure.

Referring to FIG. 29, the service providing device 100 according to an example of the present disclosure processes distributed cloud rendering based on 3-dimensional virtual space interior design information manufactured by one or more user terminals 300, 400, 500 and configures realistic interior design scene image contents corresponding to one or more viewpoints (S1101).

Further, the service providing device 100 matches the realistic scene image contents to the manufacturer information and registers them on the database of the storing portion 180 (S1103).

Further, the service providing device 100 provides a brokerage interface authoring tool using the realistic scene image contents via the market platform interface to the real estate business operator terminal (S1105).

Here, the brokerage interface authoring tool may include an interface which may index and select product information to be registered on the market platform, and the realistic scene image contents corresponding to that from the real estate business operator terminal 500.

As aforementioned, the realistic scene image contents may be mapped with tag information corresponding to interior design products or styles arranged in the indoor space, so that the brokerage interface authoring tool may provide a function of indexing one or more realistic scene image contents corresponding to product information inputted by the real estate business operator terminal 500 using the tag information and arranging them on the brokerage interface. For example, if real estate construction product information inputted by the real estate business operator terminal 500 includes specific interior design product or style information and the like, it may index the realistic scene image contents including the specific interior design product or style information as the tag information and provide them via the brokerage interface.

Further, the service providing device 100 registers real estate product information on the market platform interface according to brokerage interface authoring data inputted from the real estate business operator terminal (S1107).

Thereafter, the service providing device 100 provides realistic scene image contents via the brokerage interface of the real estate product information outputted from the consumer terminal 300 connected to the market platform (S1109).

Here, the realistic scene image contents may include tag information as aforementioned, and the consumer terminal 300 may confirm detailed contents of each tag information and the real estate product information and may input brokerage request information corresponding to that to the brokerage interface.

Further, the service providing device 100 performs brokerage processing of brokerage request information inputted from the consumer terminal 300 (S1111) and provides priorly set rate or quantity of rewards to the user terminal 400 of the content manufacturer based on brokerage information (S1113).

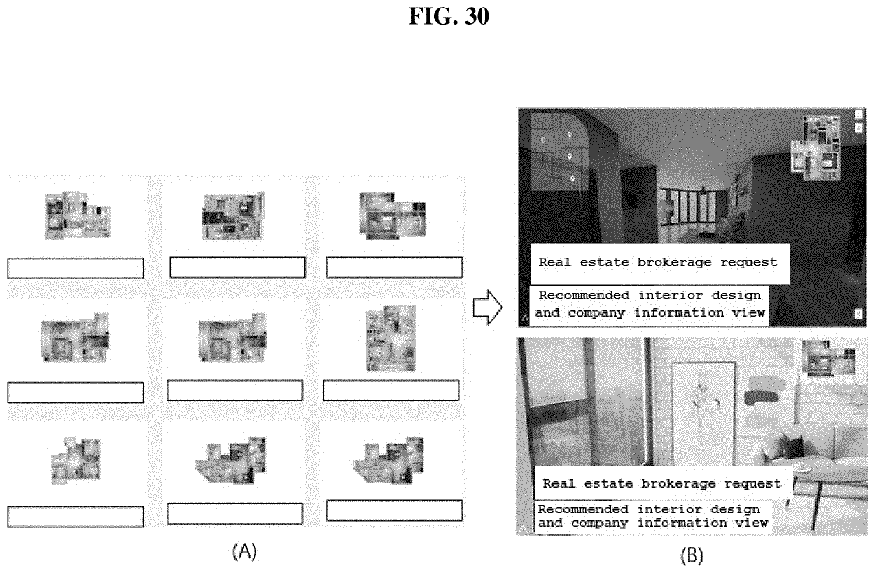

FIG. 30 is a view for describing realistic scene image-based real estate market platform interface according to an example of the present disclosure.

As shown in FIG. 30(A), the content manufacturer terminal 400 may configure one or more realistic scene image contents corresponding to an indoor space of various real estate in a distributed rendering method based on 3-dimensional virtual space interior design data according to an example of the present disclosure.

Further, as shown in FIG. 30(B), the configured realistic scene image contents may be processed as real estate product information in the real estate business operator terminal 500 and may be provided via the brokerage interface.

For example, according to an example of the present disclosure, the brokerage interface may be a general real estate brokerage interface or may include a real estate brokerage interface including a recommended interior design and interior design company-recommended information as showing in FIG. 30(B).

More specifically, for example, the interior design business operator may register a realistic scene image portfolio in the service proving device 100 using own unique information. Further, if brokerage request information inputted from the consumer terminal 300 includes required condition information, the recommended interior design and the interior design company-recommended information may be provided to the brokerage interface together with realistic scene image contents corresponding to the required condition information.

The consumer terminal 300 may select a desired interior design company or recommended interior design and be provided with realistic scene images corresponding to the interior design portfolio of the interior design business operator, and together with requesting the real estate business operator terminal 500 for a real estate brokerage, interior design construction may be requested to the selected interior design business operator.

Also, the service providing device 100 may consider the priority order corresponding to required condition information of the brokerage request information, determine a recommended interior design business operator, and provide a realistic scene image content-based portfolio of the determined business operator. The required condition information may exemplify for example, an interior design target, an interior design type, an address, a building name, a unit price of construction, a construction period, and the like.

Further, the service providing device 100 if a brokerage request or counseling request corresponding to the brokerage interface is confirmed, may pay rewards to a manufacturer account of the content manufacturer terminal 400 corresponding to realistic scene images provided from the brokerage interface, and a rate or quantity of rewards may be determined according to at least one of the number of visitors, the number of like, an evaluation score, the number of favorite registration, brokerage performance information or counseling performance information corresponding to the brokerage interface.

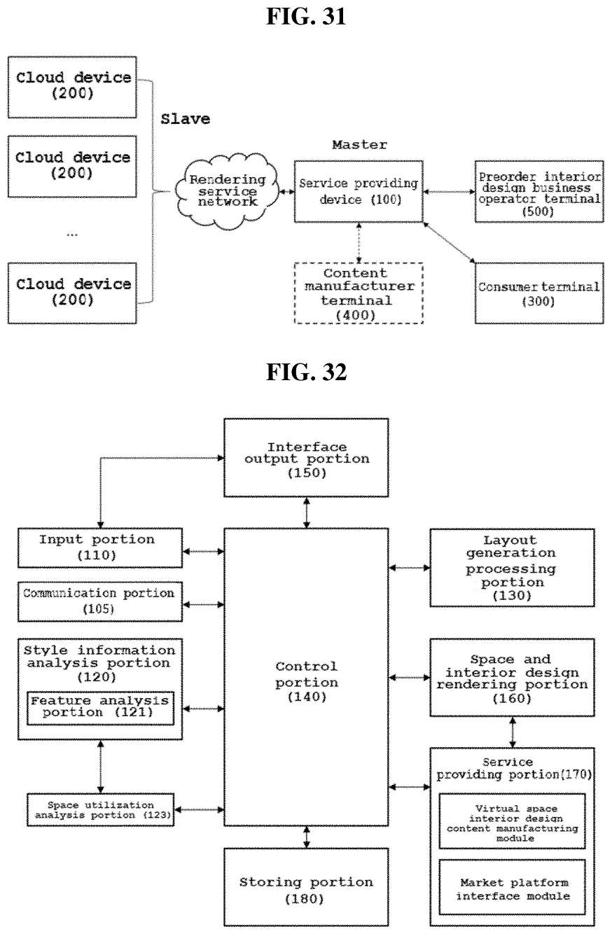

FIGS. 31 to 34 are views for describing a system and an operation according to a fourth example of the present disclosure.

FIG. 31 is a view for schematically describing a whole system according to a fourth example of the present disclosure.

With reference to FIG. 31, a whole system according to the fourth example of the present disclosure includes a service providing device 100, one or more cloud devices 200, a consumer terminal 300, a content manufacturer terminal 400, and a preorder interior design business operator terminal 500.

In advance, the consumer terminal 300, the content manufacturer terminal 400, and the preorder interior design business operator terminal 500 described in the specification may be commonly referred to as user terminals 300, 400, 500 according to a general function. In advance, the description with respect to this general function is identically described in FIG. 2, and thus it is omitted.

The preorder interior design business operator terminal 500 may be a user terminal of a business operator who provides interior design products and services and may generate a preorder interface including product information to be sold using realistic scene image contents registered on the service providing device 100 and request the service providing device 100 to register the generated preorder interface. The preorder interface requested to be registered may be registered on an interior design-related market platform interface provided by the service providing device 100.

For example, the product information to be sold may include an interior design construction product and the realistic scene image contents may be provided as a construction sample image of the interior design construction product. Further, in order to generate the preorder interface, the service providing device 100 may provide a preorder interface authoring service including the construction sample image to the preorder interior design business operator terminal 500 and may register preorder interior design product information based on authoring data inputted from the preorder interior design business operator terminal 500, on an interior design preorder market platform interface.

Accordingly, the service providing device 100 may provide the preorder interior design product information including the realistic scene image contents to one or more consumer terminals 300 connected to the market platform interface. The service providing device 100 may collect ordering information inputted via the preorder interface corresponding to the preorder interior design product information from the consumer terminal 300 and may perform payment processing.

By the process as the above, the service providing device 100 may make the preorder interior design business operator terminal 500 generate the preorder interface which includes preorder interior design product information with low costs and high quality using realistic scene images configured by various content manufacturer terminals 400 and may receive ordering information of the consumer terminal 300 with respect to this preorder interface and may process payment. Thus, the interior design preorder market platform may be provided more efficiently and with few costs.

Also, manufacturer information of the content manufacturer terminal 400 may be used for calculating rewards corresponding to the realistic scene image. For example, in case that inquiries and payment processing of the preorder interior design product information are completed or are registered on the market platform interface, the service providing device 100 may calculate rewards with respect to use of the realistic scene image and pay or provide the rewards corresponding to the manufacturer information.

Further, the content manufacturer terminal 400 may be the same as the preorder interior design business operator terminal 500. For example, the preorder interior design business operator terminal 500 itself may directly configure a design and a sample furniture to be constructed or an interior design as a separate 3-dimensional virtual space content data, process realistic image rendering and process to register it on the interior design preorder market platform. In this case, the content manufacturer terminal 400 may be substitutively configured as the preorder interior design business operator terminal 500.

Detailed components of each device to realize the above are more specifically described with reference to FIG. 32.

With reference to FIG. 32, the service providing device 100 includes a communication portion 105, an input portion 110, a style information analysis portion 120, a layout generation processing portion 130, a control portion 140, an interface output portion 150, a space and interior design rendering portion 160, a service providing portion 170, and a storing portion 180. Since components shown in FIG. 32 are not necessary, a terminal having more components or fewer components than them may be realized. Also, its configuration is similar with a configuration of FIG. 2, and thus the description with respect to the same element is omitted.

The service providing portion 170 may include a market platform interface module for processing a preorder market platform service and ordering information and may include a virtual space interior design content manufacturing module for supporting to manufacture and register realistic scene image contents to be used in the market platform interface module.

For example, the service providing portion 170 may make the content manufacturer terminal 400 manufacture realistic scene image contents including furniture information, a purchase link, and the like used for interior design arrangement and may obtain manufacturer information and may register matching on the database of a storing portion 180.

Also, for example, the service providing portion 170 may output a tagging interface of one or more of furniture information included in video images in which the interior design layout automation information is rendered via the interface output portion 150 to the user terminals 300, 400, 500 and may process a service of providing the furniture information and purchase link according to user input corresponding to the tagging interface.

Accordingly, the user not only may be provided with the automated interior design layout service but also may check detailed information and purchase information of furniture for actually applying it to the user's indoor space directly.

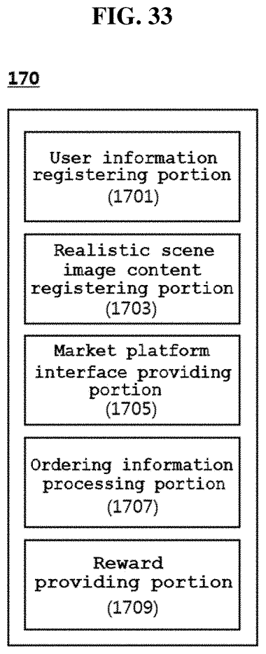

FIG. 33 is a block diagram for more specifically describing a service providing portion according to an example of the present disclosure.

Referring to FIG. 33, the service providing portion 170 according to an example of the present disclosure includes a user information registering portion 1701, a realistic scene image content registering portion 1703, a market platform interface providing portion 1705, an ordering information processing portion 1707, and a reward providing portion 1709.

The user information registering portion 1701 may receive user information of each of the consumer terminal 300, the content manufacturer terminal 400, and the preorder interior design business operator terminal 500 and may process to priorly store and register in the storing portion 180.

Further, the realistic scene image content registering portion 1703 may process distributed rendering based on virtual space content data manufactured by one or more user terminals according to a request of the content manufacturer terminal 400, configure one or more realistic scene image contents, match the one or more realistic scene image contents to manufacturer information, and process to store and register them in the database of the storing portion 180.

Further, the market platform interface providing portion 1705 may provide a preorder interface authoring service using the realistic scene image to the preorder interior design business operator terminal 500 and may process to register preorder interior design product information based on authoring data inputted from the preorder interior design business operator terminal 500, on the interior design preorder market platform interface. The registered product information may be shared with one or more consumer terminals 300.

Accordingly, the market platform interface providing portion 1705 may provide the preorder interior design product information to the consumer terminal 300 via the interior design preorder market platform interface. Here, the preorder interior design product information may include the aforementioned realistic scene image contents.

Further, the ordering information processing portion 1707 perform confirmation and payment processing of ordering information inputted from the consumer terminal 300. Further, the ordering information processing portion 1707 may have one or more ordering payment modules (not shown) to support ordering information and payment processing of the consumer terminal 300, wherein payment information may be transferred to the reward providing portion 1709.

Further, the reward providing portion 1709 may provide or pay a priorly set rate or quantity rewards corresponding to manufacturer information of the realistic scene image applied to the preorder interior design product information to an account corresponding to the manufacturer information.

Further, the priorly set rate or quantity of the rewards may be determined in various ways.

For example, the priorly set rate or quantity of the rewards may be determined according to evaluation information of the realistic scene image collected via the interior design preorder market platform interface corresponding to the preorder interior design product information. The evaluation information may exemplify the number of searching, a rating value, the number of selecting like, and the like.

Also, the reward providing portion 1709 may receive not only rewards with respect to ordering payment but also content fees from the preorder interior design business operator terminal if the preorder interior design product information is registered on the interior design preorder market platform interface and may transfer them to the user account corresponding to the manufacturer information.

Further, for example, the interior design preorder market platform interface may include a cloud funding market platform interface and the priorly set rate or quantity may be determined in the reward providing portion 1709 according to performance information of the cloud funding.

For example, according to an example of the present disclosure, the reward providing portion 1709 may be set to provide rewards only when cloud funding is completed up to a target amount. In this case, the rate or quantity of rewards paid corresponding to manufacturer information of the content manufacturer terminal 400 may be varied according to a funding result. For example, when funding is successful or only when a certain rate or more is achieved compared to the target amount, the rewards may be paid to the user account corresponding to content manufacturer information.

Thanks to processing as the above, the realistic interior design scene image based on establishment of 3-dimensional indoor space data of each user may be easily configured, and it is possible to provide the preorder market platform interface based on the configured realistic scene image contents. Accordingly, preorder interface creation of the preorder interior design product information based on the competitive realistic interior design scene image is easily processed without needs of excessive human resources.

Also, the manufacturer information of these realistic interior design scene image contents is registered, so that it is possible to provide rewards according to fee charging or reward setting of the preorder interior design business operator. Thus, participation of the content manufacturers may be increased and the market platform service may be activated.

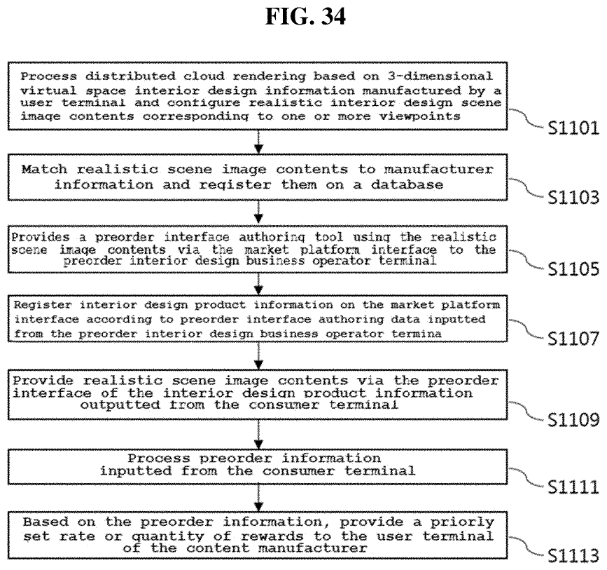

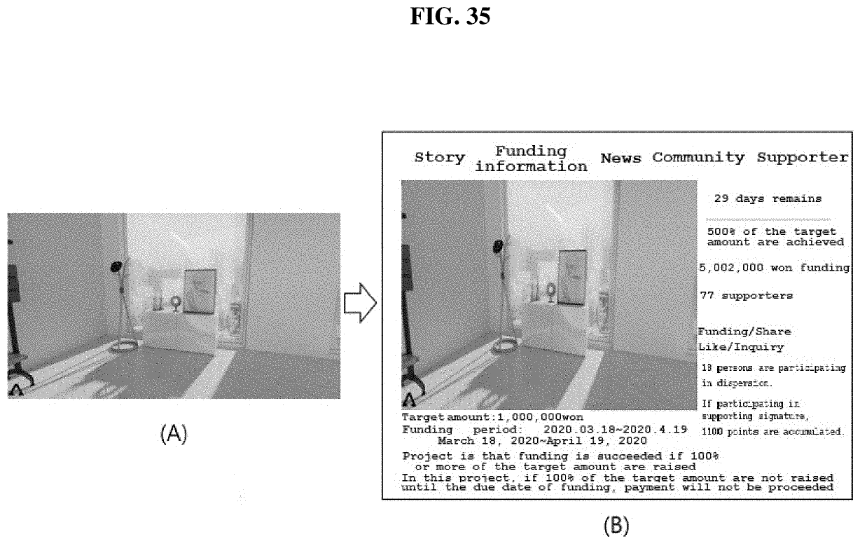

FIG. 34 is a flow chart for more specifically describing a service providing method according to an example of the present disclosure.

Referring to FIG. 34, the service providing device 100 according to an example of the present disclosure processes distributed cloud rendering based on 3-dimensional virtual space interior design information manufactured by one or more user terminals 300, 400, 500 and configures realistic interior design scene image contents corresponding to one or more viewpoints (S1101).

Further, the service providing device 100 matches the realistic scene image contents to the manufacturer information and registers them on the database of the storing portion 180 (S1103).

Further, the service providing device 100 provides a preorder interface authoring tool using the realistic scene image contents via the market platform interface to the preorder interior design business operator terminal (S1105).

Here, the preorder interface authoring tool may include an interface which may index and select product information to be registered on the market platform, and the realistic scene image contents corresponding to that from the preorder interior design business operator terminal 500.

As aforementioned, the realistic scene image contents may be mapped with tag information corresponding to interior design products or styles arranged in the indoor space, so that the preorder interface authoring tool may provide a function of indexing one or more realistic scene image contents corresponding to product information inputted by the preorder interior design business operator terminal 500 using the tag information and arranging them on the preorder interface. For example, if interior design construction product information inputted by the preorder interior design business operator terminal 500 includes specific interior design product or style information and the like, it may index the realistic scene image contents including the specific interior design product or style information as the tag information and may provide them via the preorder interface.

Further, the service providing device 100 registers preorder interior design product information on the market platform interface according to preorder interface authoring data inputted from the preorder interior design business operator terminal (S1107).

Thereafter, the service providing device 100 provides realistic scene image contents via the preorder interface of the preorder interior design product information outputted from the consumer terminal 300 connected to the market platform (S1109).

Here, the realistic scene image contents may include tag information as aforementioned, and the consumer terminal 300 may confirm a detailed estimate of each tag information and the preorder interior design product information and may input ordering information corresponding to that to the preorder interface.

Further, the service providing device 100 performs payment processing of ordering information inputted from the consumer terminal 300 (S1111) and provides a priorly set rate or quantity of rewards to the user terminal 400 of the content manufacturer based on payment information (S1113).

FIG. 35 is a view for describing a realistic scene image-based market platform interface according to an example of the present disclosure.

As shown in FIG. 35(A), the content manufacturer terminal 400 may configure one or more realistic scene image contents in a distributed rendering method based on 3-dimensional virtual space interior design data according to an example of the present disclosure.

Further, as shown in FIG. 35(B), the configured realistic scene image contents may be processed as preorder interior design product information in the preorder interior design business operator terminal 500 and may be provided via the preorder interface.

Also, according to an example of the present disclosure, the preorder interface may be a general payment preorder interface or may include the preorder interface for interior design construction products as shown in FIG. 35(B).

Also, as shown in FIG. 35(B), the preorder interface according to an example of the present disclosure may include a cloud funding-type preorder interface. The funding-type preorder interface may include interior design product information provided only when the cloud funding is completed up to the target amount. In this case, rewards paid corresponding to manufacturer information of the content manufacturer terminal 400 may be also varied according to a funding result. For example, when funding is successful or only when a certain rate or more is achieved compared to the target amount, the rewards may be paid to the user account corresponding to content manufacturer information.

Further, the service providing device 100 if a request for ordering or counseling corresponding to the preorder interface is confirmed, may pay rewards corresponding to manufacturer information of the content manufacturer terminal 400, and a rate or quantity of rewards may be determined according to at least one of the number of visitors, the number of like, an evaluation score, the number of favorite registration, ordering performance information or counseling performance information corresponding to the preorder interface.

A method according to the present disclosure as aforementioned may be stored in a recording medium which is manufactured as a program for running in a computer and is computer-readable, and examples of the computer-readable recording medium are ROM, RAM, CD-ROM, a magnetic tape, a floppy disk, an optical data storage device, and the like and also includes one implemented as a form of a carrier wave (for example, transmission via the Internet).

The computer-readable recording medium may store and run code which may be distributed on a computer system connected by a network and may be read by a computer in a distributed way. Further, a functional program, code, and code segments for implementing the method may be easily inferred by programmers in the art to which the present disclosure pertain.

Also, preferable examples of the present disclosure are shown and described as the above. However, it is to be understood that the present disclosure is not limited to the aforementioned specific examples, and various modifications may be implemented by those skilled in the art without deviating from the gist of the present disclosure claimed in the scope of claims. These modifications should not be individually understood from the technical spirit or prospect of the present disclosure.

1. An operation method of a service providing device, comprising steps of:
processing distributed rendering based on virtual space content data manufactured by one or more user terminals and configuring one or more realistic scene image contents;
matching the one or more realistic scene image contents to manufacturer information and registering them on a database;
providing an ordering interface authoring service using the realistic scene images to an interior design business operator terminal; and
registering interior design product information based on authoring data inputted from the interior design business operator terminal on an interior design market platform interface.

2. The operation method of the service providing device of claim 1, further comprising steps of:
providing the interior design product information via the interior design market platform interface to a consumer terminal; and
providing a priorly set rate or quantity of rewards corresponding to manufacturer information of the realistic scene image applied to the interior design product information according to payment processing of ordering information inputted from the consumer terminal.

3. The operation method of the service providing device of claim 2,
the priorly set rate or quantity of rewards is determined according to evaluation information of the realistic scene image collected via the interior design market platform interface corresponding to the interior design product information.

4. The operation method of the service providing device of claim 2, further comprising a step of:
in the case that the interior design product information is registered on the interior design market platform interface, receiving content fees from the interior design business operator terminal and transferring them to a user account corresponding to the manufacturer information.

5. The operation method of the service providing device of claim 2,
the interior design market platform interface includes an interior design construction market platform interface, and
the priorly set rate or quantity of rewards is determined according to ordering performance information or counseling performance information corresponding to the interior design construction.

6. The operation method of the service providing device of claim 1,
the step of configuring the one or more realistic scene image contents comprises steps of:
configuring optimization processed-distributed processing data for distributed rendering processing of the realistic scene image projected from a first viewpoint corresponding to 3-dimensional virtual space contents to be provided to the user terminal;
transferring the configured distributed processing data to one or more cloud devices connected to a rendering service network; and
receiving distributedly rendered realistic scene partial images from the cloud device and configuring the realistic scene image of the first viewpoint corresponding to the 3-dimensional virtual space contents.

7. The operation method of the service providing device of claim 6,
the step of configuring the one or more realistic scene image contents comprises steps of:
setting a conversion object within the virtual space contents corresponding to the first realistic scene image;
determining a partial conversion boundary area corresponding to an affected range by object conversion corresponding to a first object before conversion and a second object after conversion according to conversion object setting;
performing re-rendering processing of the realistic scene image corresponding to the partial conversion boundary area; and
combining the re-rendered realistic scene image part and the remaining part except the partial conversion boundary area of the first realistic scene image to configure a second realistic scene image where the first object is converted to the second object.

8. A service providing device, comprising:
a space and interior design rendering portion which processes distributed rendering based on virtual space content data manufactured by one or more user terminals and configures one or more realistic scene image contents; and
a service providing portion which matches the one or more realistic scene image contents to manufacturer information and registers them on a database, wherein
the service providing portion comprises:
a virtual space interior design content manufacturing module which provides an ordering interface authoring service using the realistic scene images to an interior design business operator terminal; and
a market platform interface module which registers interior design product information based on authoring data inputted from the interior design business operator terminal on an interior design market platform interface.

9. The service providing device of claim 8,
the service providing portion comprises:
a market platform interface providing portion which provides the interior design product information via the interior design market platform interface to a consumer terminal; and
a reward providing portion which provides a priorly set rate or quantity of rewards corresponding to manufacturer information of the realistic scene image applied to the interior design product information according to payment processing of ordering information inputted from the consumer terminal.

10. The service providing device of claim 9,
the priorly set rate or quantity of rewards is determined according to evaluation information of the realistic scene image collected via the interior design market platform interface corresponding to the interior design product information.

11. The service providing device of claim 9,
the reword providing portion in the case that the interior design product information is registered on the interior design market platform interface, receives content fees from the interior design business operator terminal and transfers them to a user account corresponding to the manufacturer information.

12. The service providing device of claim 9,
the interior design market platform interface includes an interior design construction market platform interface, and
the priorly set rate or quantity of rewards is determined according to ordering performance information or counseling performance information corresponding to the interior design construction.

13. The service providing device of claim 8,
the space and interior design rendering portion configures optimization-processed distributed processing data for distributed rendering processing of the realistic scene images projected from a first viewpoint corresponding to a 3-dimensional virtual space contents to be provided to the user terminal, transfers the configured distributed processing data to one or more cloud devices connected to a rendering service network, receives distributedly rendered realistic scene partial images from the cloud devices, and configures the realistic scene images of the first viewpoint corresponding to the 3-dimensional virtual space contents.

14. The service providing device of claim 13,
the space and interior design rendering portion sets a conversion object within the virtual space contents corresponding to the first realistic scene image, determines a partial conversion boundary area corresponding to an affected range by object conversion corresponding to a first object before conversion and a second object after conversion according to conversion object setting, performs re-rendering processing of the realistic scene image corresponding to the partial conversion boundary area, and combines the re-rendered realistic scene image part and the remaining part except the partial conversion boundary area of the first realistic scene image to configure a second realistic scene image where the first object is converted to the second object.

15. The service providing device of claim 8,
the rendering portion processes distributed rendering based on 3-dimensional furniture data to configure one or more realistic scene image contents corresponding to a furniture item to be sold, the service providing portion provides a furniture sales interface authoring service using the realistic scene image contents to a furniture seller terminal and registers furniture product information based on authoring data inputted from the furniture seller terminal on a furniture sales market platform interface.

16. The service providing device of claim 8,
the service providing portion further comprises:
a virtual space interior design content manufacturing module which provides a brokerage interface authoring service using the realistic scene images to a real estate business operator terminal; and
a real estate brokerage market platform interface module which registers real estate product information based on authoring data inputted from the real estate business operator terminal on a real estate market platform interface.

17. The service providing device of claim 8,
the service providing portion further comprises:
a virtual space interior design content manufacturing module which provides a preorder interface authoring service using the realistic scene images to a preorder interior design business operator terminal; and
a preorder market platform interface module which registers preorder interior design product information based on authoring data inputted from the preorder interior design business operator terminal on an interior design preorder market platform interface.

18. A computer readable recording medium on which a program for performing the method described in claim 1 in a computer is recorded.
